(19) United States
(12) Patent Application Publication
(10) Pub. No.: US 2011/0238537 A1
(43) Pub. Date: Sep. 29, 2011

(54) WORK IN PROCESS INVENTORY ANALYSIS TOOL

(75) Inventors: Laird M. Wilson, Lasalle (CA); Douglas J. Harris, Oxford, MI (US); Eric A. Gonzales, Howell, MI (US); Edwin R. Kincer, Fenton, MI (US)

(73) Assignee: GM GLOBAL TECHNOLOGY OPERATIONS, INC., Detroit, MI (US)

(21) Appl. No.: 12/729,551

(22) Filed: Mar. 23, 2010

(51) Int. Cl. G06Q 10/00; G06F 17/00

(52) U.S. Cl. 705/29; 700/100; 700/99; 700/107; 705/348

(57) ABSTRACT

A method of managing work-in-process (WIP) inventory includes receiving inputs, via a user interface of a computer processing device. The inputs correspond to variables defined for modules. Each of the modules includes a set of instructions for determining and quantifying a corresponding WIP inventory driver. The method also includes executing instructions on the inputs by one or more of the modules. The inputs are applied to corresponding modules based on respective variables defined for the modules. The method further includes deriving a quantified WIP inventory resulting from execution of the instructions categorized by corresponding WIP inventory drivers.

### FIELD OF THE INVENTION

Exemplary embodiments of the present invention are related to inventory management and, more specifically, to a method, system, and computer program product for facilitating work-in-process (WIP) inventory analysis and management.

### BACKGROUND

Business process management techniques have been derived to promote business efficiency and improve on business processes over time. Business process management seeks to align an enterprise or organization with customer demand. Inventory management is one of the many business processes handled by an enterprise. Inventory management manages the timing and quantities of materials or goods to be ordered and stocked by the enterprise in order that demand is satisfied without incurring excess costs. That is, too much inventory on hand increases the costs of doing business, while too little inventory can impair relationships between the enterprise and its customer base.

Inventory items, or units, that are released for manufacturing are referred to as work-in-process (WIP) materials. These materials may include units currently being processed on equipment, units in transit within a manufacturing facility, and units awaiting processing on equipment in the facility. Typically, WIP units are parts and/or assemblies that will become ‘finished goods,’ or saleable products. In efforts to maximize cash flow, manufacturing enterprises continuously strive to find ways to control costs, such as investments in WIP inventory. However, this is not an easy task, as WIP is often impacted by factors, such as complex variability in manufacturing processes, and/or disparate policies set by inter-enterprise organizations (e.g., material control, manufacturing, and engineering). Moreover, oftentimes the particular reasons for WIP inventory levels are unknown or misunderstood by the enterprise.

Various methods have been developed to reduce excess inventory. For example, target levels of inventory may be set by decree of management or other designated entity. However, without further analysis of the inventory system or related requirements, these reductions are not likely to be maintained for a sustainable period of time. For example, reductions that are implemented in order to realize a mandated target level of inventory may often result in a loss of throughput, thereby impacting profits. Another solution applies math to selected portions of an identified inventory issue or concern. Although some inventory reductions could be sustained with this method, other opportunities for inventory reduction may be missed. Yet another solution uses sophisticated discrete event simulation analysis to determine required inventory levels. However, the models used in this solution generally require a great deal of time to develop. Also, there are typically a limited number of people that can perform these simulation analyses, which can significantly reduce the number of studies that can be done with this method. Further, the simulations are not usually performed by manufacturing support personnel, which can prevent these individuals from developing the intuition necessary to generate successful solutions to similar future inventory problems.

Accordingly, it is desirable to provide a way to quantify WIP inventory by cause, or driver, and utilize this information to identify opportunities for inventory reduction.

### SUMMARY OF THE INVENTION

In one exemplary embodiment of the present invention, a method of managing work-in-process (WIP) inventory is provided. The method includes receiving inputs, via a user interface of a computer processing device. The inputs correspond to variables defined for modules. Each of the modules includes a set of instructions for determining and quantifying a corresponding WIP inventory driver. The method also includes executing instructions on the inputs by one or more of the modules. The inputs are applied to corresponding modules based on respective variables defined for the modules. The method further includes deriving a quantified WIP inventory resulting from execution of the instructions categorized by corresponding WIP inventory drivers.

In another exemplary embodiment of the present invention, a system for managing WIP inventory is provided. The system includes a host system computer and an application executing on the host system computer. The application includes a user interface and modules that implement a method. The method includes receiving inputs via the user interface of a computer processing device. The inputs correspond to variables defined for modules. Each of the modules includes a set of instructions for determining and quantifying a corresponding WIP inventory driver. The method also includes executing instructions on the inputs by one or more of the modules. The inputs are applied to corresponding modules based on respective variables defined for the modules. The method further includes deriving a quantified WIP inventory resulting from execution of the instructions categorized by corresponding WIP inventory drivers.

In yet another exemplary embodiment of the present invention, a computer program product for managing WIP inventory is provided. The computer program product includes a storage medium encoded with machine-readable computer program code, which when executed by a computer implements a method. The method includes receiving inputs, via a user interface of a computer processing device. The inputs correspond to variables defined for modules. Each of the modules includes a set of instructions for determining and quantifying a corresponding WIP inventory driver. The method also includes executing instructions on the inputs by one or more of the modules. The inputs are applied to corresponding modules based on respective variables defined for the modules. The method further includes deriving a quantified WIP inventory resulting from execution of the instructions categorized by corresponding WIP inventory drivers.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a diagram depicting a system for facilitating inventory management in accordance with an exemplary embodiment;

FIG. 2 is flow diagram describing a process for facilitating inventory management in accordance with an exemplary embodiment;

FIG. 3 is a user interface screen provided by an inventory management application for receiving input data in accordance with an exemplary embodiment;

FIG. 4 is a user interface screen provided by the inventory management application for outputting a breakdown of inventory information by driver in accordance with an exemplary embodiment;

FIG. 5 is a diagram depicting a portion of a manufacturing system in an exemplary embodiment;

FIG. 6A is a diagram depicting elements of the manufacturing system of FIG. 5;

FIG. 6B is a detailed view of a first portion of the user interface screen described in FIG. 3 in accordance with an exemplary embodiment;

FIG. 7A is a diagram depicting another portion of the manufacturing system shown in FIG. 5 in an exemplary embodiment;

FIG. 7B is a detailed view of a second portion of the user interface screen described in FIG. 3 in accordance with an exemplary embodiment;

FIG. 8A is a diagram depicting elements of the manufacturing system shown in FIG. 5 in an exemplary embodiment;

FIG. 8B is a detailed view of a third portion of the user interface screen described in FIG. 3 in accordance with an exemplary embodiment;

FIG. 9A is a detailed view of a fourth portion of the user interface screen described in FIG. 3 in an exemplary embodiment;

FIG. 9B illustrates a set of formulas used in calculating data used in the fourth portion of the user interface screen of FIG. 3 in accordance with an exemplary embodiment;

FIG. 10A is a diagram depicting elements of the manufacturing system shown in FIG. 5 in an exemplary embodiment;

FIG. 10B is a detailed view of a fifth portion of the user interface screen described in FIG. 3 in accordance with an exemplary embodiment; and

FIG. 11 is a diagram depicting formulas used by the inventory management application to assess output results for inventory drivers of the inventory management system in accordance with an exemplary embodiment.

### DESCRIPTION OF THE EMBODIMENTS

In accordance with an exemplary embodiment of the present invention, inventory management of work-in-process (WIP) materials is provided. The inventory management processes identify and quantify inventory reduction opportunities for an organization with respect to WIP inventory. An optimal inventory level may be calculated by comparing the optimal level to the current level that exists in the facility. WIP inventory may include materials that are released for manufacturing. These materials may include units currently being processed on equipment, units in transit within a manufacturing facility, and units awaiting processing on equipment in the facility and, optionally, outside of the facility. WIP units refer to parts and/or assemblies that will become ‘finished goods,’ or saleable products.

The inventory management processes described herein simplify the analyses of inventory drivers by using application logic and a user interface for input and calculation of results. The inventory management processes include pre-defined inventory driver modules, which have been validated using simulation techniques. In an exemplary embodiment, the inventory driver modules are each defined by a set of instructions, which when executed perform calculations on inputs to variables to determine and quantify a corresponding driver of WIP inventory. In an exemplary embodiment, an inventory driver includes one or more elements (such as people, events, or conditions), which cause or otherwise affect the acquisition, handling, and movement of inventory with respect to a manufacturing environment. In addition, based upon information input by one or more users in response to specific questions (e.g., as relating to the associated variables), the inventory management processes, via the modules, calculate an inventory value that is representative of the current, future, or ideal state for the system or organization. A separate inventory model may be created for each of these states. A current state reflects quantified WIP inventory levels as they currently exist in the system (e.g., implementing a particular manufacturing plan). A future, or prospective, state reflects quantified, yet unrealized, WIP inventory levels based upon a prospective manufacturing plan. An ideal state reflects quantified WIP inventory levels determined to keep the system running at required capacity as defined by the enterprise system (e.g., required capacity criteria may defined as that which produces maximum output and/or profits, as well as satisfy any other goals of the enterprise system). When an ideal inventory level is determined, the opportunity for WIP inventory reduction may be determined by comparing the quantified WIP inventory levels of a current state to that representative of an ideal state and evaluating potential modifications to the current state WIP inventory levels accordingly. Inventory models created for current, future, and ideal states may be saved and re-used. An accompanying training manual may be used to provide the manufacturing support team the knowledge necessary to develop plans to reduce the inventory to the ideal state.

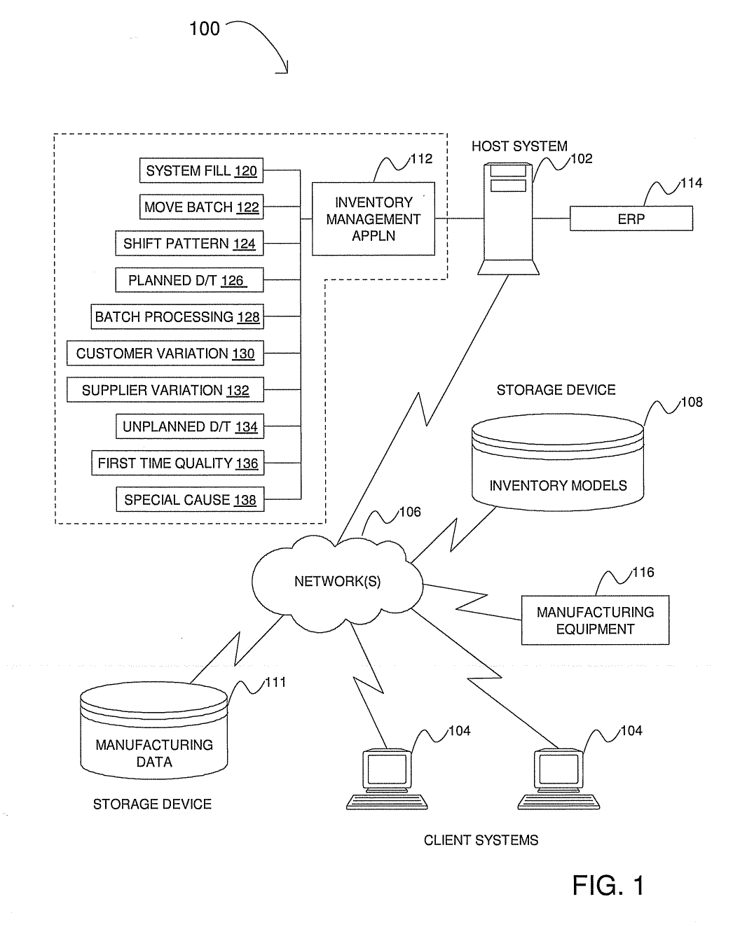

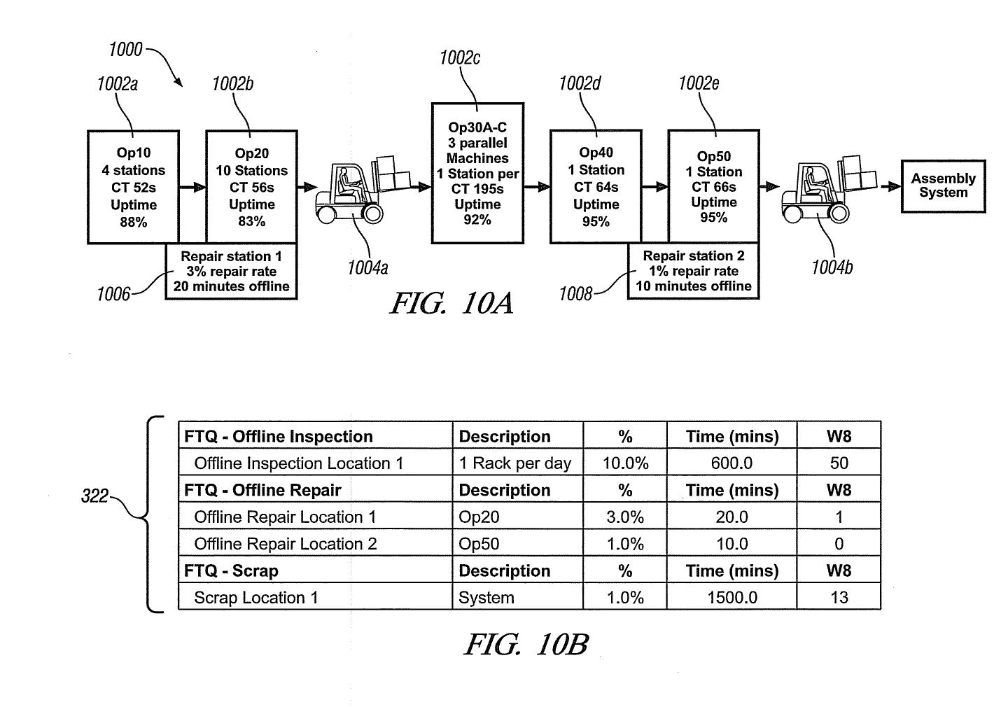

Turning now to FIG. 1, an exemplary enterprise system 100 for facilitating inventory management will now be described. The system 100 includes a host system 102 executing computer instructions for performing the inventory management processes described herein. Host system 102 may comprise a high-speed computer processing device, such as a mainframe computer, to manage the volume of operations governed by an entity for which the inventory management is executing. In one exemplary embodiment, the host system 102 may be part of an enterprise (e.g., a manufacturing business) that implements the inventory management processes. As described herein, the host system 102 represents a manufacturing enterprise. The manufacturing enterprise includes equipment typically found in a manufacturing environment (e.g., process equipment (also referred to as ‘machines’), stations of the equipment, inventory transport equipment, buffers, and the like). This equipment is collectively referred to herein as ‘manufacturing equipment’ 116. The manufacturing equipment 116 may be in communication with the host system 102 and/or client systems 104, e.g., over a network. A sample manufacturing system environment that includes the manufacturing equipment 116 is shown in FIGS. 5, 6A, 7A, 8A, and 10A.

In an exemplary embodiment, the system 100 depicted in FIG. 1 includes one or more client systems 104 through which users at one or more geographic locations may contact the host system 102. The client systems 104 and the manufacturing equipment 116 may be coupled to the host system 102 via one or more networks 106. Each client system 104 may be implemented using a general-purpose computer executing a computer program for carrying out the processes described herein. The client systems 104 may be personal computers (e.g., a lap top, a personal digital assistant) or host attached terminals. If the client systems 104 are personal computers, the processing described herein may be shared by a client system 104 and the host system 102 (e.g., by providing an applet to the client system 104). Client systems 104 may be operated by authorized users (e.g., inventory specialists or manufacturing personnel) of the inventory management processes described herein.

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. A client system 104 and, optionally manufacturing equipment 116, may be coupled to the host system 102 through multiple networks (e.g., intranet and Internet) so that not all client systems 104/manufacturing equipment 116 are coupled to the host system 102 through the same network. One or more of the client systems 104, manufacturing equipment 116, and the host system 102 may be connected to the networks 106 in a wireless fashion. In one embodiment, the networks include an intranet and one or more client systems 104 execute a user interface application (e.g., a web browser) to contact the host system 102 through the networks 106. In another exemplary embodiment, the client system 104 is connected directly (i.e., not through the networks 106) to the host system 102 and the host system 102 contains memory for storing data in support of the inventory management. Alternatively, one or more separate storage devices (e.g., storage devices 108 and 111) may be implemented for this purpose.

The storage device 108 includes a data repository with data relating to inventory management, such as inventory models produced by the inventory management processes, as well as other data/information desired by the entity representing the host system 102 of FIG. 1. The storage device 111 includes a data repository with data relating to manufacturing, such as locations/descriptions of machines, stations, and buffer locations. Other manufacturing data may include manufacturing processes (i.e., operations performed on these machines), cycle times, demand, uptime, throughput, WIP costs, and other desired information. The storage devices 108/111 are logically addressable as a consolidated data source across a distributed environment that includes networks 106. Information stored in the storage devices 108/111 may be retrieved and manipulated via the host system 102, the client systems 104, and/or elements of the manufacturing environment (e.g., manufacturing equipment 116).

In alternative exemplary embodiments, one or both of the storage devices 108/111 may be located on a client system 104. The host system 102 depicted in the system of FIG. 1 may be implemented using one or more servers operating in response to a computer program stored in a storage medium accessible by the server. The host system 102 may operate as a network server (e.g., a web server) to communicate with the client systems 104. The host system 102 handles sending and receiving information to and from the client systems 104 and can perform associated tasks. The host system 102 may also include a firewall to prevent unauthorized access to the host system 102 and enforce any limitations on authorized access. For instance, an administrator may have access to the entire system and have authority to modify portions of the system. A firewall may be implemented using conventional hardware and/or software as is known in the art.

The host system 102 may also operate as an application server. The host system 102 executes one or more computer programs to provide inventory management processes. As shown in FIG. 1, for purposes of illustration, the inventory management is implemented by an inventory management application 112 executing on the host system 102. The host system 102 may also execute other applications typically implemented in a manufacturing environment. For purposes of illustration, the host system 102 executes an enterprise resource planning (ERP) tool 114.

As indicated above, processing may be shared by the client systems 104 and the host system 102 by providing an application (e.g., java applet) to the client systems 104. Alternatively, the client system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions. It will be understood that the inventory management described in FIG. 1 may be implemented in hardware, software, or a combination thereof.

In an exemplary embodiment, the inventory management application 112 includes inventory driver modules 120-138 described in detail below. The inventory driver modules 120-138 each reflect a specific cause that drives inventory. One or more processes attributed to each of the modules 120-138 are applied to determine, via the application 112, the drivers of WIP inventory in a manufacturing environment. In particular, the application 112 provides a detailed breakdown of WIP inventory within the manufacturing environment of enterprise system 100 and the reasons for its existence based upon inputs made to the modules 120-138.

In an exemplary embodiment, the application 112 also enables a user to calculate ideal levels of inventory needed to keep the manufacturing system running at required capacity (e.g., to achieve an ideal state). This ideal amount of inventory may vary from system to system, and from time period to time period, depending on factors such as changes in demand, changes in technology (e.g., upgraded manufacturing machinery), and changes in product design, to name a few. The ideal amount of inventory may be derived by calculating quantities of WIP inventory needed to balance the costs and benefits of having inventory on hand (i.e., to obtain or maintain required levels of production for a facility based upon its operations, equipment, running time, etc. in view of the costs of having such quantities available and on hand).

The outputs produced from both scenarios (i.e., current inventory state versus ideal inventory state) may be stored (e.g., in storage device 108) as inventory models for future use and reference. These outputs may also be used to compare the current state versus the ideal state to determine which drivers of inventory have the most impact on the WIP inventory levels. Those drivers having the most impact on the WIP inventory can be reviewed and resolutions to minimize such impact can be addressed. For example, if it is determined based upon these outputs that two of the ten drivers significantly impact the WIP inventory as compared to the remaining eight drivers, the organization associated with the manufacturing environment (e.g., enterprise system 100) may focus more time and energy on finding solutions for mitigating the impact found with respect to the two drivers.

Additionally, each of the modules 120-138 represents a domain of inventory drivers. A particular subset of the modules may apply to one manufacturing facility, while a different subset of the modules 120-138 may apply to another manufacturing facility, depending upon factors such as product line, machinery used, or culture of people in the plant, to name a few.

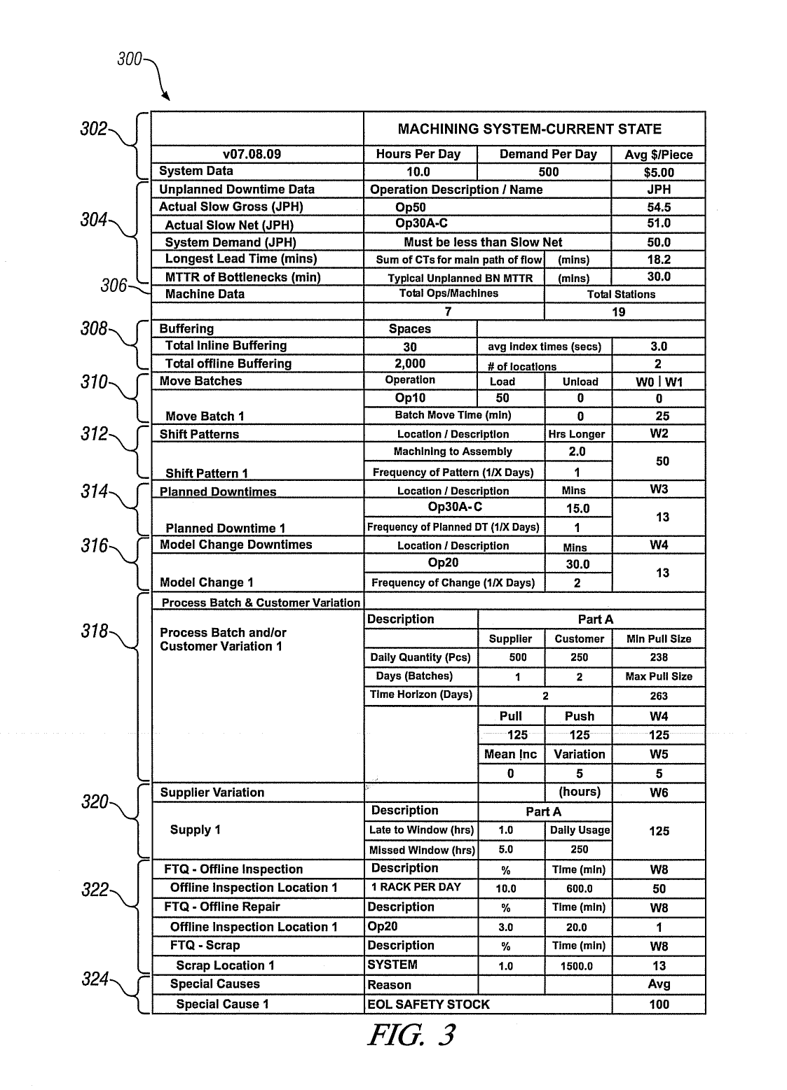

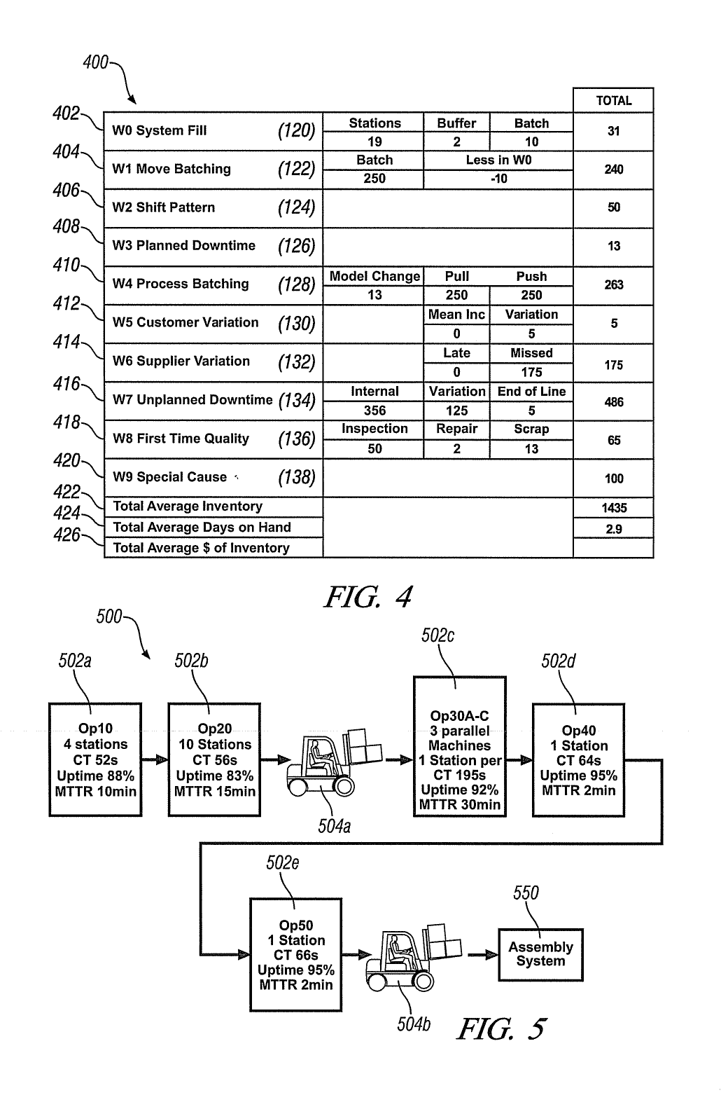

In an exemplary embodiment, a user of the application 112 enters data prompted by the application 112 via a user interface screen, a sample of which is shown in FIG. 3. The application 112 processes the inputs provided by the user in conjunction with data specific to the manufacturing environment and outputs information, such as WIP quantities by driver. As indicated above, these outputs enable the user to easily identify which of the drivers have the greatest impact on the manufacturing environment, as well as opportunities for improvement. A sample user interface screen illustrating the results (outputs) of this processing is shown in FIG. 4.

The drivers are implemented as modules 120-138 (also denoted as W0-W9, respectively), and will now be described in accordance with exemplary embodiments. A SYSTEM FILL module 120 identifies a minimum number of units (e.g., WIP) to fill the system (e.g., manufacturing system 500 of FIG. 5) and run at 100% uptime rate. A MOVE BATCH module 122 quantifies any impact on WIP due to moving containers of units (e.g., WIP inventory materials). A SHIFT PATTERN module 124 quantifies any impact on WIP due to different running times attributed to different portions of the manufacturing process. A PLANNED DOWNTIME module 126 quantifies any impact on WIP due to planned downtimes. A BATCH PROCESSING module 128 (also referred to herein as ‘PROCESS BATCHING module’) quantifies any impact on WIP due to proliferation. A CUSTOMER VARIATION module 130 quantifies any impact on WIP due to schedule volatility. A SUPPLIER VARIATION module 132 quantifies any impact on WIP due to supplier delivery volatility. An UNPLANNED DOWNTIME module 134 quantifies any impact on WIP due to potential unforeseen equipment breakdowns. A FIRST TIME QUALITY (FTQ) module 136 quantifies any impact on WIP due to inspection, repair, and scrap. A SPECIAL CAUSE module 138 quantifies any impact on WIP due to other unspecified policies.

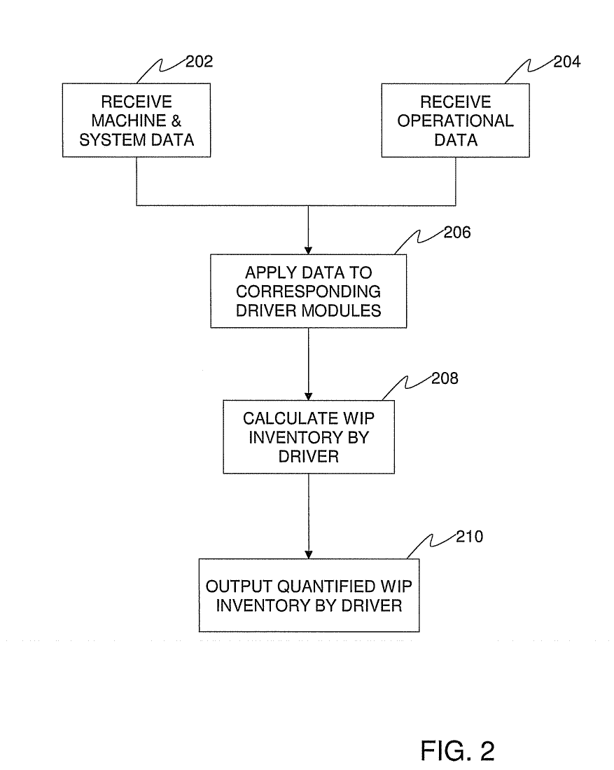

The inputs provided to the inventory management system via the user interface screen 300 of FIG. 3 are used to calculate the output values for one or more of the output fields (or field sets) shown in FIG. 4. That is, the modules 120-138 interoperate via the inventory management application 112 by utilizing the inputs to perform calculations that determine the ideal amount of inventory for each particular cause of WIP inventory in a manufacturing system (e.g., a manufacturing system associated with system 100 of FIG. 1). The modules 120-138 include processes for determining WIP quantities relative to the inventory drivers. These processes include operations performed on values provided for corresponding variables that have been defined via the application 112 for these processes, the values of which are determined, at least in part, through user inputs via the user interface screen of FIG. 3. For example, a user enters a value for a variable ‘Demand,’ which is, in turn, applied to computations defined for one or more processes of one or more of the driver modules 120-138 to derive the outputs, a sample of which is provided in FIG. 4. The interoperability of these modules 120-138 to produce the outputs in FIG. 4 will be described further in FIG. 2.

Turning now to FIG. 2, an exemplary process for implementing the inventory management processes will now be described. For purposes of illustration, the processes described in FIG. 2 are applicable to a manufacturing environment (e.g., as shown in FIGS. 1, 5, 6A, 7A, 8A, and 10A).

At step 202, system data and machine data relating to the manufacturing environment is received by the application 112. The data may be input, e.g., via a user interface of a computer processing device, such as user interface screen 300 of FIG. 3. Alternatively, some of the data (e.g., machine/operation data) may be acquired automatically from a storage system of the enterprise system 100, e.g., storage device 111 of FIG. 1. At step 204, operational data is input to the application 112 via the user interface screen 300. As indicated above, each of the inputs corresponds to a variable (e.g., a field for one or more field sets 302-324 of FIG. 3) defined for one or more of the modules 120-138. Each of the modules 120-138 includes one or more processes for determining and quantifying a corresponding WIP inventory driver.

At step 206, the data input from steps 202 and 204 is applied to corresponding inventory driver modules 120-138 based upon the variables defined for each of the modules. At step 208, the WIP inventory information is calculated for each of the inventory drivers 120-138.

At step 210, the quantified WIP inventory resulting from step 208 is output for display and review (e.g., via the user interface screen 400 FIG. 4). As shown in FIG. 4 the output, or quantified WIP inventory, is categorized (broken down) by WIP inventory drivers 120-138 (where the drivers 120-138 each correspond to respective field sets 402-420). As used herein in FIGS. 3 and 4, the term ‘field sets’ refer to data fields that are grouped according to their relationships and/or other defined criteria.

The inputs, processing, and outputs described with respect to the flow diagram of FIG. 2 will now be described in further detail, and in conjunction with the diagrams depicted in FIGS. 3-11, in accordance with exemplary embodiments.

The application 112 receives inputs regarding system and machine data (step 202) via field sets 302 and 306 of user interface screen 300. As shown in field set 306, the inputs include a total number of machines or operations and a total number of stations of the manufacturing environment. An operation may contain many stations, such as a transfer machine. By way of illustration, a manufacturing system 500 shown in FIG. 5 includes seven operations 502a-502e. These operations are performed at one or more stations before the WIP is transported to an end location (e.g., assembly system 550). For example, as shown in system 500, there are 19 stations (four stations for operation 502a, ten stations for operation 502b, three stations for operation 502c (one station times three parallel machines), one station for operation 502d, and one station for operation 502e). The total number of stations includes those that are idle. The value reflecting the variable, ‘total number of stations’ is then output to field set 402 of user interface screen 400 (i.e., within the location labeled ‘Stations’).

Other inputs for machine and system data are shown in field set 302 of user interface screen 300. As shown in field set 302, the inputs include a system name description and system state (e.g., current, future, or ideal). As indicated above, the application 112 enables a user to obtain a detailed breakdown of WIP inventory within the manufacturing facility and the reasons for its existence by entering data concerning the current system of the manufacturing environment. Additionally, the application 112 enables a user to obtain a prospective or ideal breakdown of WIP inventory based upon improved values input to the user interface screen 300 and processed by the modules 120-138. The improved values reflect those determined to be most effective in realizing the ideal state. As indicated above, the ideal levels of inventory refer to those levels needed to keep the manufacturing environment running at required capacity. These models (current, future, and ideal) may be identified by the description provided in field set 302 (in the example shown in FIG. 3, the description is ‘MACHINING SYSTEM—CURRENT STATE’).

Other inputs also include total running time, which reflects the total number of hours per day the system or machine runs (including lunchtime and breaks). The total running time is provided in a location of field set 302 labeled ‘Hours Per Day,’ which is shown in field set 302 as ‘10.0.’ Inputs to field set 302 also include a quantity of system demand (e.g., presented in units per day), such that the inventory may be measured by ‘Days on Hand.’ Total system demand is provided in a location of field set 302 labeled ‘Demand Per Day.’ Inputs to field set 302 also include an averaged value (i.e., the average worth or value) of a particular unit in the system. The averaged value is provided in a location of field set 302 labeled ‘Avg $/Piece.’

As indicated above in FIG. 2, the application 112 receives inputs relating to operational data (step 204) via the user interface screen 300 of FIG. 3. These inputs will now be described in an exemplary embodiment.

As indicated above, the application 112 captures inputs that are processed by the modules 120-138. The SYSTEM FILL module 120 represents one of these modules. System fill may be defined as the number of parts required in the system to ensure that it can run at 100% uptime. There are three components used in deriving the system fill requirement. The first component provides a value that represents the total number of stations in all machines of the system. This value ensures that all machining stations are running. The second component provides a value that accounts for a quantity of parts conveyed between machines in the system. The third component provides a value that accounts for a quantity of parts associated with move batching operations. System fill values are calculated and output to the user interface screen 400 as will now be described.

Operational data inputs include buffering data in field set 308 of user interface screen 300. The sum of all inline buffering locations throughout the manufacturing environment (e.g., manufacturing system illustrated in FIG. 5, 6A, 8A, and 10A) is entered in a location of field set 308 labeled ‘Total Inline Buffering’ in the column labeled ‘Spaces.’ An inline buffer refers to a conveyor that connects two operations. Parts may flow directly through these conveyors when all machines are running (where inline buffer values are used in calculations for the SYSTEM FILL module 120 and BATCH MOVE module 122) or may act as temporary stopping (i.e., buffering) points for WIP materials when one or more of these machines are broken down (where inline buffer values are used in calculations for the SYSTEM FILL module 120 and the UNPLANNED DOWNTIME module 134). The length of the conveyors determines their storage capacity, which storage capacity is expressed in units referred to herein as ‘spaces’ when used as a buffer (where ‘spaces’ is synonymous with the number of parts that fit on the conveyor). For example, suppose a part subject to manufacture is one foot in length and the conveyor is 30 feet in length. Based upon the length of the part and the length of the conveyor (or multiple conveyors), e.g., there are ten inline buffering spaces between operations 502a and 502b, fifteen inline buffering spaces between operations 502c and 502d, and five inline buffering spaces between operations 502d and 502e (not shown). The sum of these spaces total 30, which value is entered in field set 308 as shown in FIG. 3. An index time refers to the time it takes for a part to travel its own length. For example, if the part is one foot in length, and the conveyor moves at 0.3 feet per second, then the index time would be three seconds. An average index time represents the average time it takes for a part to travel through each of the inline buffering spaces. This value is entered into a location of field set 308 labeled ‘Total Inline Buffering’ in the row labeled ‘avg index time (secs).

The SYSTEM FILL module 120 also calculates the amount of conveyor capacity that is required to keep the system full (i.e., running at 100% uptime). This value may be determined by multiplying the index time (e.g., three seconds) by the number of spaces on the conveyor (e.g., 30 spaces). The resulting value ‘90’ represents the minimum travel time across that particular conveyor. The SYSTEM FILL module 120 also identifies the cycle times of the machines on either side of the conveyor in order to calculate the conveyor capacity required for system fill. The conveyor needs to have sufficient parts occupied thereon to ensure that a part exits the conveyor at the speed of the slower of the two machines. For example, if the first machine cycles at 20 seconds and the second machine cycles at 10 seconds, the conveyor needs at least enough parts on it to provide a part every 20 seconds to the second machine. If the travel time across the conveyor is 40 seconds (e.g., a conveyor with an index time of 4 and a length of 10 spaces), then two parts are required to be dedicated to system fill on that conveyor (i.e., 40/20). Using the example data in FIG. 3, a system fill is calculated for conveyors for the entire production system. As shown in data field set 308 of FIG. 3, there are 30 inline buffer spaces with an average index time of three seconds. Thus, it will take a minimum of 90 seconds for the parts to travel through the conveyors. For system fill analysis, parts should be provided at the rate of the slowest machine in the system. In this example, data field set 304 shows the actual slow gross machine to be running at 54.5 JPH, or 66 seconds. The resulting system fill value due to inline buffer spaces would be calculated as 90/66, or two parts. The remaining 28 spaces for the conveyors may be used by the UNPLANNED DOWNTIME module 134, as described further herein. This system fill value due to inline buffer spaces is reflected in field set 402 of FIG. 2 within the location labeled ‘Buffer.’

In addition, the sum of all offline buffering locations throughout the manufacturing environment (e.g., manufacturing system shown in FIG. 5, 6A, 8A, and 10A), including automatic and manual offload positions, is entered in a location of field set 308 labeled ‘Total Offline Buffering’ in the column labeled ‘Spaces.’ Offline buffers are used to accommodate for lengthy machine downtime. At these offline buffer locations, parts are removed from the inline conveyors for later reintroduction to the process. These offline buffers usually occur at multiple locations within the process. Similar to inline buffers, the maximum number of parts that may be placed in these offline buffers is described in units called spaces. For example, if a manufacturing process has 2000 spaces identified in two offline buffering locations, this information is entered into the corresponding locations in field set 308 (i.e., the value 2000 is entered in a location labeled ‘Total Offline Buffering’ under column labeled ‘Spaces,’ and the value ‘2’ is entered in a column labeled ‘# of locations’) as shown, e.g., in FIG. 3.

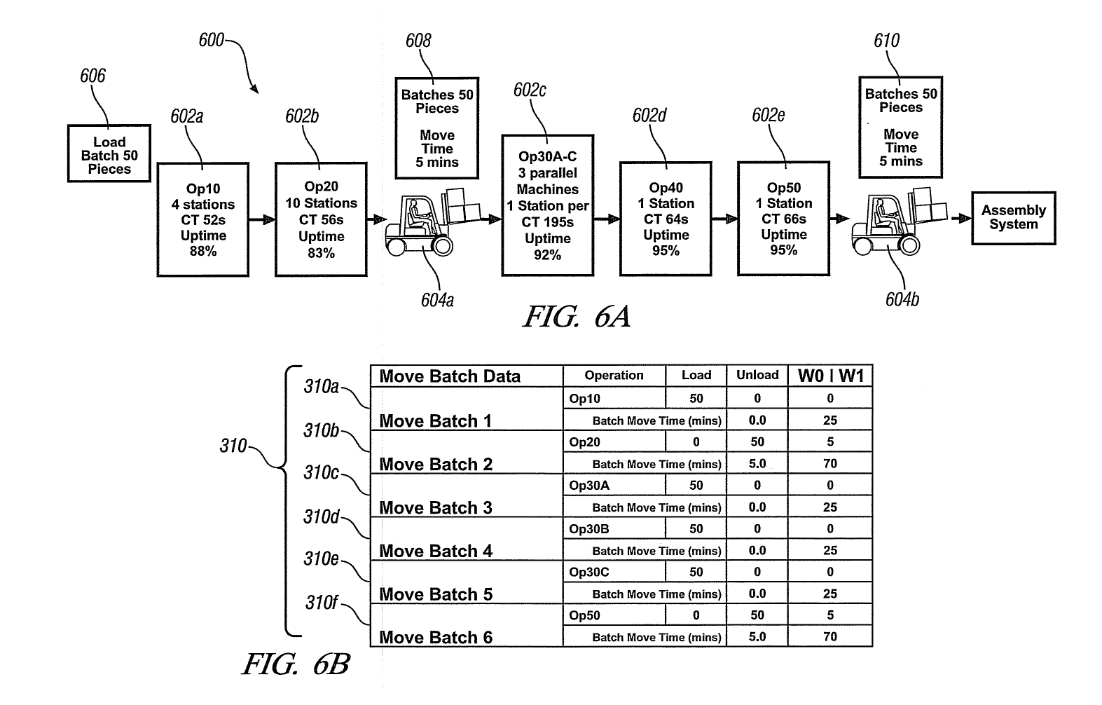

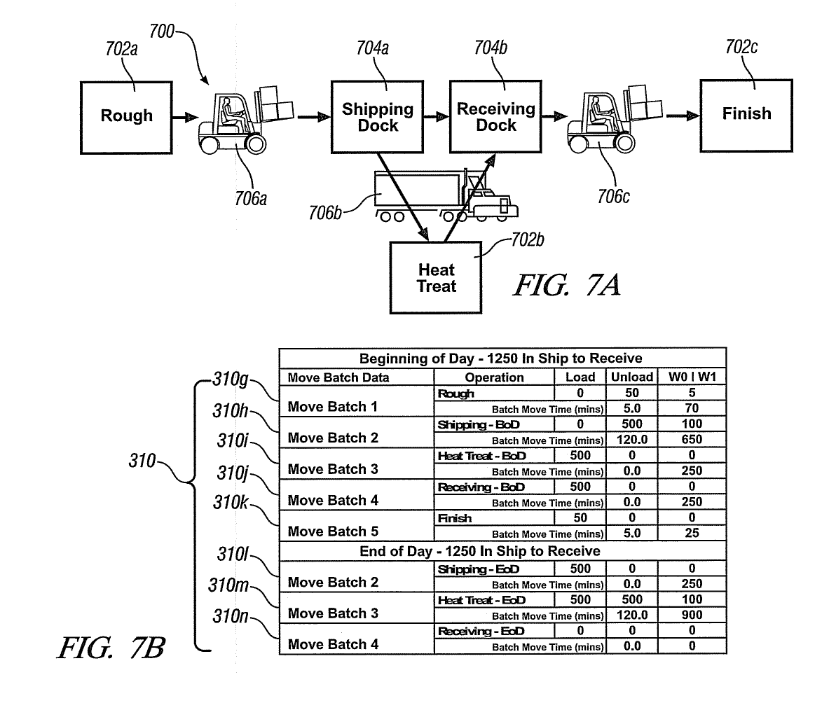

Returning now to FIG. 2, operational data inputs (step 204) also include batch move data in field set 310 of user interface screen 300. While only a single batch item line (i.e., ‘Move Batch 1’) is shown in field set 310 of FIG. 3 for illustrative purposes, it will be understood that many batch items may be entered in field 310. For example, if the user interface 300 of the application 112 is represented in a spreadsheet format, the user can add additional batch lines using a simple navigational option provided by the program. The data inputs for the batch field set 310 are further illustrated in FIG. 6B (for internal batch operations) and in FIG. 7B (for external batch operations), as will now be described.

A manufacturing system 600 is shown in FIG. 6A, along with elements provided to illustrate the sample data inputs to the field set 310 illustrated in FIG. 6B. The manufacturing system 600 includes operations and machines substantially similar to those described in FIG. 5 and so will not be further defined. Additionally, a manufacturing system 700 is shown in FIG. 7A, along with elements provided to illustrate the sample data inputs to the field set 310 illustrated in FIG. 7B. In an exemplary embodiment, the manufacturing system 700 represents an extension of the manufacturing system 500 of FIG. 5.

As shown in FIG. 6B, operation names or descriptions of the locations where batching processes occur are entered into field set 310 of FIG. 6B in a column labeled ‘Operation.’ As shown in FIG. 6B, for example, a first batch process named ‘Move Batch 1’ is described for ‘Op10’ in a sub-field set 310a of field set 310. This is also reflected in FIG. 6A via a load batch operation 606 for the manufacturing system 600. Additionally, a number of units identified in preparation for loading (before the corresponding operation) is entered in sub-field set 310a in a column labeled ‘Load.’ Further, a number of units collected after completion of the operation, and in preparation for the next operation, is entered in sub-field set 310a in a column labeled ‘Unload.’ The load and unload values may each be entered as ‘0’ or ‘1’ if there is no batch process. Also, an amount of time that it takes to move the batch to the next operation is entered in sub-field set 310a in a row labeled ‘Batch Move Time (mins).’ Once this information in sub-field set 310a is entered, the application 112 calculates any increase to average inventory that is required due to the time to move this batch of parts using the load/unload values and batch move times (i.e., ‘Move Batch 1’ for Op10). The result of this calculation is entered in the first line of sub-field set 310a under column W0/W1, whereby the value for this result corresponds to W0 (i.e., module 120).

As shown in FIG. 6B, there are six move batch operations, illustrated as sub-field sets 310a-310f of field set 310. The process described above with respect to field set 310a is repeated for each batch line item (i.e., sub-field sets 310b-310f). Once completed, the application 112 uses the results entered for each of the batches (i.e., ‘Move Batch 1’ through ‘Move Batch 6’), in particular, the entries in column W0/W1 to calculate the outputs to portions of field sets 402 and 404 of user interface screen 400. In particular, the sum of all values in the column labeled ‘W0/W1’ in field set 310 (including all sub-field sets 310a-310f of field set 310) is entered into field set 404 under a column labeled ‘Batch.’ This value (shown as ‘250’) represents the total calculated increase to average inventory due to all move batch operations (e.g., 310a-310f). Since this is a system fill (W0) value caused by a batch move (W1), the SYSTEM FILL module 120 enters it as a positive number in field set 402 in the column labeled ‘Batch,’ and the MOVE BATCH module 122 enters this value as a negative number in field set 404 in the column labeled ‘Less in W0.’

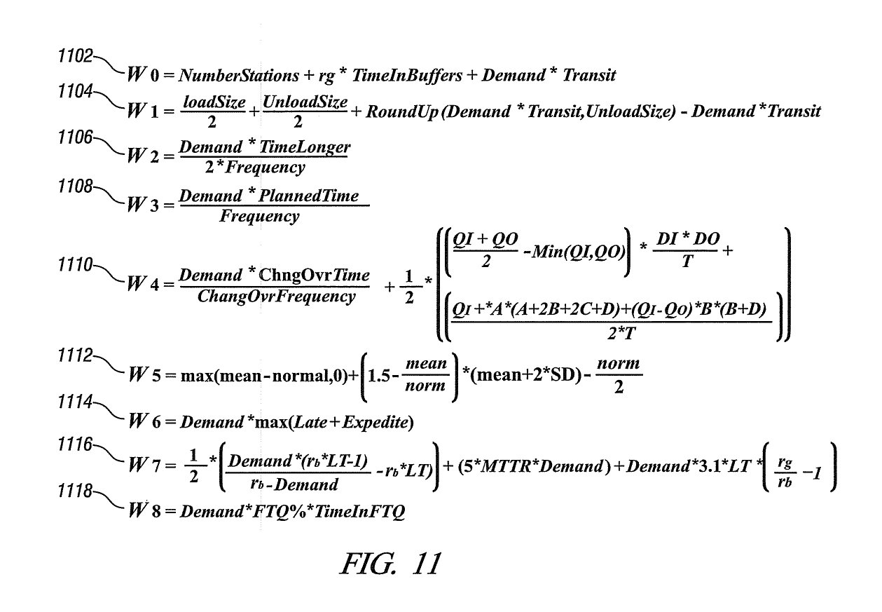

As shown in field set 402 of FIG. 4, system fill values representing the three system fill components include the ‘Stations’ value derived by the SYSTEM FILL module 120, which reflects the increase to average inventory due to the manufacturing system's requirement to fill the collective operations (e.g., 19 stations). Additionally, the ‘Buffer’ value derived by the SYSTEM FILL module 120 reflects a calculated increase to average inventory due to the need to keep operations fed and maintain the customer demand based on inline buffer size and transit time. Further, the ‘Batch’ value derived by SYSTEM FILL module 120 in field set 402 reflects the calculated increase to average inventory due to the need to keep operations fed and maintain the customer demand based on the collective batch move times. The SYSTEM FILL module 120 sums the values in field set 402 resulting in the value shown in the column of field set 402 labeled ‘Total.’ This value represents the total calculated increase to average inventory related to the sum of stations, buffer and batch inventory. The ‘Batch’ value in field set 402 is also populated in field set 404 in a column labeled ‘Less in W0’ to avoid duplication in counting the parts required for the time to move the batches. In one exemplary embodiment, the ‘total’ value in field set 402 may be derived via a formula 1102 shown in FIG. 11 (i.e., NumberStations+r_{g}*TimeInBuffers+Demand*Transit, whereby r_{g} represents the rate of the slow gross machine identified in field set 304).

The MOVE BATCH module 122 processes the entries made in field set 310, in addition to information calculated by the SYSTEM FILL module 120, to derive the outputs shown in field set 404 of FIG. 4. In particular, the MOVE BATCH module 122 subtracts the ‘Batch’ value in field set 402 from the batch value in field set 404 (in column labeled ‘Less in W0’), which reflects the total calculated increase to average inventory due to all move batch operations (e.g., from sub-field sets 310a-310f) in order to keep machines fed and maintain the customer demand based on batch movement, which results in a total calculated increase to average inventory related to batch movement less the inventory required for system fill operations (i.e., the value ‘240’ provided in field set 404 under the column labeled ‘Total’).

In addition to the internal batch movement processes described above, the inventory management processes also enable similar calculations to be made for outside batch movement processes (e.g., those occurring at the edge or outside of the manufacturing environment) via the MOVE BATCH module 122. The manufacturing system 700 of FIG. 7A includes a sample of various operations 702a-702c and locations 704a/704b through which batch movement (e.g., 706a-706c) may occur. As shown in FIG. 7A, a ‘Rough’ operation 702a represents a set of operations that shape a part, or unit, of a batch to its approximate final dimensions. Rough operations are well known to those skilled in the art and will not be described further.

As shown in FIG. 7B, a value of ‘0’ is entered in a sub-field set 310g under a column labeled ‘Load’ indicating the amount of parts in a container prior to performing the first operation 702a. A first batch movement (illustrated in block 706a) occurs in order to move the batch from the rough operation 702a to a shipping dock 704a. By way of illustration, suppose the batch contains 50 pieces or units, and the amount of time required to move the batch from operation 702a to the shipping dock 704a is five minutes. The number of pieces (50) is entered in field set 310 of FIG. 7B in sub-field set 310g under a column labeled, ‘Unload,’ to reflect that 50 units are to be unloaded as a result of the rough operation 702a prior to the batch movement. Likewise, the amount of time required to move the batch (e.g., 5 minutes) is entered in field set 310 of FIG. 7B within sub-field set 310g at a location corresponding to the batch movement time (shown in FIG. 7B as ‘Batch Move Time (mins)’).

The shipping dock 704a represents a location where the machined parts are held until they are loaded to a truck for transport to the next process. As shown in FIGS. 7A and 7B, the 500 pieces are unloaded at the shipping dock 704a (sub-field set 310h) and subsequently loaded onto the truck 706b for further processing (in this case, the process is a heat treatment 702b (sub-field set 310i), which is performed by a third party manufacturer outside of the manufacturing facility). As shown in FIG. 7B, the time required for movement of the batch via the truck is 120 minutes (sub-field set 310i). Heat treatment 702b represents a process that hardens metal. Following the heat treatment 702b, the treated parts are transported back to the manufacturing system 700 and received at the receiving dock 704b. FIG. 7B reflects this activity in sub-field set 310j. Receiving dock 704b (sub-field set 310j) represents the location in the manufacturing system 700 where the treated parts are stored after being delivered by the truck 706b before being used by the next process.

As shown in FIG. 7A, parts from the receiving dock 704b are transported (i.e., batch movement 706c) to a finishing operation 702c (sub-field set 310k). The finishing process 702c represents a set of operations that shapes the parts into their final dimensions. Thus, as described above, the data supplied in sub-field sets 310g-310n of FIG. 7B reflect containers for the batches before and after a process and movement of parts between processes.

The MOVE BATCH module 122 processes the data provided in FIG. 7B in a similar manner to that described above in FIG. 6B and the results are output to field sets 402 and 404 of FIG. 4 (not shown) in a similar manner to that described above in FIG. 6B. Thus, if the enterprise system 100 of FIG. 1 utilizes the features provided by the inventory management application 112 with respect to the external batch processing (described in FIGS. 7A and 7B), the MOVE BATCH module 122 integrates the calculations performed in FIG. 6B with those performed in FIG. 7B and the results are output to field sets 402 and 404 of FIG. 4 (e.g., the sum of the entries in the W0/W1 column of sub-field sets 310g-310n are added to the sum of entries in the W0/W1 column of sub-field sets 310a-310f). In one exemplary embodiment, the ‘total’ value in field set 404 may be derived via a formula 1104 shown in FIG. 11.

Returning to FIG. 2, additional operational data inputs (step 204) include data for assessing the affects of shift patterns on WIP inventory. Shift patterns refer to differences in running times between upstream and downstream operations (e.g., a situation in a manufacturing process when an upstream/downstream system is producing while the downstream/upstream system is not). A user inputs data relating to shift patterns in field set 312 of user interface screen 300. While only a single shift pattern line item is shown in field set 312 of FIG. 3 for illustrative purposes, it will be understood that many shift patterns may be entered in field 312. For example, if the user interface 300 of the application 112 is represented in a spreadsheet format, the user can add additional shift pattern line items using a simple navigational option provided by the program.

In field set 312, the user enters a location or description in which the hours running differs upstream versus downstream (i.e., where the shift pattern occurs). This information is entered in the location below a column labeled ‘Location/Description’ in field set 312 (shown as ‘MACHINING TO ASSEMBLY’). The user also enters the time difference between the two systems that make up the shift pattern. The time difference may be entered in hours, as shown in the column labeled ‘Hrs Longer’ in field set 312. In addition, the user enters the number of days between consecutive occurrences of the shift pattern on the second line of field set 312 directly adjacent to the field labeled ‘Frequency of Pattern (1/x Days’) (shown as ‘1’ in FIG. 3).

The SHIFT PATTERN module 124 calculates the increase to average inventory due to this particular shift pattern. For example, suppose the difference between the upstream and downstream systems is two hours and the frequency of occurrence of the pattern is every day, as shown in field set 312 of FIG. 3. The SHIFT PATTERN module 124 calculates the total increase to average inventory for the particular shift pattern by multiplying the demand (e.g., 50 JPH) by the number of hours longer (e.g., two) and divides this result by the product of two times the frequency of occurrence (e.g., one, for once a day), where ‘two times the frequency of occurrence’ yields an average). The resulting calculation, in this instance, 50, is entered into the field set 312 under the column labeled ‘W2.’ The SHIFT PATTERN module 124 applies this same computation to any additional shift patterns identified in the field set 312, and enters the sum of the results for all of the shift pattern computations in field set 406 of FIG. 4 under a column labeled ‘Total.’ In this example, there is only one shift pattern identified in field set 312, so the result for this particular shift pattern is entered in the field set 406. In one exemplary embodiment, the ‘total’ value in field set 406 may be derived via a formula 1106 shown in FIG. 11.

Returning again to FIG. 2, additional operational data inputs (step 204) include data for assessing the affects of planned downtime to WIP inventory, as well as data for assessing the affects of model changes to WIP inventory. Planned downtime refers to identified or scheduled time periods in which one or more machines are taken offline, e.g., to perform preventative maintenance. Model changes refer to downtime scheduled for changing the tools within a machine in order to make a different part type. A user inputs data relating to planned downtime in field set 314 of user interface screen 300. The user also inputs data relating to model change downtimes in field set 316 of user interface screen 300. While only a single line item is shown in each of field sets 314 and 316 of FIG. 3 for illustrative purposes, it will be understood that many scheduled downtimes and/or model change downtimes may be entered in respective field sets 314 and 316. For example, if the user interface 300 of the application 112 is represented in a spreadsheet format, the user can add additional line items using a simple navigational option provided by the program.

In field set 314, the user enters a location or description of the downtime. This information is entered in the location below a column labeled ‘Location/Description’ in field set 314 (‘Op30A-C’). In addition, the user enters the frequency of occurrence of the downtime in terms of number of days on the second line of field set 314 directly adjacent to the field labeled ‘Frequency of Planned DT (1/x Days’). In addition, the user enters the time needed to satisfy the protection requirement. This information is entered on the first line of field set 314 under the column labeled ‘Mins.’ Likewise, in field set 316, the user enters a location or description of the downtime relating to a model change. This information is entered in the location below a column labeled ‘Location/Description’ in field set 316. In addition, the user enters the frequency of occurrence of the downtime in terms of number of days on the second line of field set 316 directly adjacent to the field labeled ‘Frequency of Change (1/x Days’). In addition, the user enters the time needed to satisfy the protection requirement. This information is entered on the first line of field set 316 under the column labeled ‘Mins.’

The PLANNED DOWNTIME module 126 calculates an average inventory impact (in terms of ‘units’ of inventory) for this specific planned downtime and enters this value in field set 314 in a column labeled ‘W3.’ Additionally, utilizing the PROCESS BATCHING module 128, the average inventory impact (in terms of ‘units’ of inventory) is calculated for this specific model change and the value is entered in field set 316 in the column labeled ‘W4.’ Using the example data provided in FIG. 3 (and the system 500 of FIG. 5), there is one planned downtime for Op30A-C (502c) of 15 minutes. This planned downtime has a frequency occurrence of once per day. As the three operations Op30A-C relate to three parallel machines, there is only a need to protect for one 15 minute period (i.e., to reconcile for any loss due to this planned downtime). As shown in field set 314 of FIG. 3, the time of 15 minutes is entered into a field under the column labeled ‘Mins’ for the corresponding operation. Also, there is one planned changeover of 30 minutes scheduled for every other day. This value is entered into the field set 316 under the column labeled ‘Mins.’ The PLANNED DOWNTIME module 126 calculates the total increase to average inventory related to the planned downtime as 13 units, as shown in column ‘W3’ of FIG. 3. This calculation is derived by multiplying the demand (50 JPH) by the planned time (15 min* 1/60), and dividing the result by the frequency of occurrence (once per day). This value, 13, is summed with the values derived for similar calculations made for each of the planned downtimes (in this example, there is only one), and the end result is entered in field set 408 of user interface 400 in the column labeled ‘Total.’ The same calculation used by the PLANNED DOWNTIME module 126 is also used by the PROCESS BATCHING module 128, which uses the result of the calculation (i.e., the result shown in field set 316 entered in the column labeled ‘W4’ as described further herein). In one exemplary embodiment, the ‘total’ value in field set 408 may be derived via a formula 1108 shown in FIG. 11.

Returning to FIG. 2, additional operational data inputs (step 204) include data for assessing the affects of process batching to WIP inventory. The PROCESS BATCHING module 128 processes the model change data entered into field set 410 of FIG. 4, along with other data input to the user interface screen 300 of FIG. 3. As shown in FIG. 3, a field set 318 receives inputs relating to daily quantities pulled/pushed for a particular unit type. In particular, the line labeled ‘Daily Quantity (Pcs)’ under the column labeled ‘Supplier’ represents the daily quantity of units produced for a particular unit type, and under the column labeled ‘Customer’ represents the daily quantity pulled for this unit type. A ‘Push’ system is one in which a supplier produces a product based on the ‘expected’ customer demand and stores it before the customer has ‘requested’ the product. Once the customer order has been fulfilled, the supplier then repeats this process. A ‘Pull’ system is one in which a supplier produces a product based on the ‘actual’ customer order. Parts do not get stored because the customer pulls immediately after there are produced. The line labeled ‘Days (Batches)’ under the column labeled ‘Supplier’ in field set 318 of FIG. 3 represents the number of days the supplier builds this type of unit in the given time horizon, and under the column ‘Customer’ in field set 318 (in the line labeled ‘Days (Batches)’) represents the number of days the customer pulls in this unit type in the given time horizon. The time horizon refers to the number of days until the schedule (i.e., push/pull sequence) repeats itself. This value is entered in the line labeled ‘Time Horizon (Days)’ in field set 318.

The PROCESS BATCHING module 128 calculates values for fields ‘Pull’ and ‘Push’ in field set 318. The calculation for the Pull value assumes that the manufacturing system is a perfect pull system (i.e., the supplier produces when the customer pulls). The calculation for the Push value assumes that the manufacturing system is a worst case push system (i.e., the supplier produces with as much delay as possible between production and pull). The PROCESS BATCHING module 128 utilizes an average of these best and worst cases to produce the output entered in the column labeled ‘W4’ of the field set 318. In an exemplary embodiment, a formula 1110 for calculating this output is shown in FIG. 11. The variables of the formula 1110 are provided below:

QI—supplier batch size

QO—customer batch size

DI—days supplier works during time horizon

DO—days customer works during time horizon

T—time horizon

A—days supplying, not pulling

B—days supplying and pulling

C—days neither supplying nor pulling

D—days pulling, not supplying.

In an exemplary embodiment, the customer batch size (i.e., ‘Daily Quantity (Pcs)) is input as an average number. However, each time the customer pulls a batch, the batch size may vary slightly from that average. This may cause an increase to inventory. Included in field set 318 are columns ‘Min Pull Size’ and ‘Max Pull Size’. The values for these columns represent the variation to the average customer batch size. CUSTOMER VARIATION module 130 calculates the increase to WIP inventory for this customer schedule variation. The following example describes the batch processing inputs of field set 318 with customer variation included. It will be understood, however, that it is possible to have customer variation without having a batch based supplier and vice versa. Each customer of the manufacturing system may have pull values that vary in size. The value entered on the line labeled ‘Daily Quantity (Pcs)’ under the ‘Customer’ column of field set 318 (shown as ‘250’) represents the size of the planned daily pull when the customer pulls this type of unit. The column labeled ‘Min Pull Size’ in field set 318 represents a value reflecting the smallest quantity of units (shown as ‘238’) a customer may pull in relation to the planned customer batch pull size. The column labeled ‘Max Pull Size’ in field set 318 represents a value reflecting the greatest quantity of units (shown as ‘263) a customer may pull in relation to the planned customer batch pull size.

The CUSTOMER VARIATION module 130 calculates values for the fields in field set 318 labeled ‘Mean Inc’ and ‘Variation.’ When a customer tends to pull more than predicted on a regular basis, the supplier needs to increase its average production to match the higher than normal pull. This increase is referred to as a ‘mean increase.’ When a customer varies its pull, assuming that the supply is constant, typically a buffer of finished inventory will increase when the customer under pulls. Additionally, the buffer should be allowed to increase to allow for over pulls. The calculated increase in buffer size due to this fluctuation is referred to as the ‘variation.’ The sum of values in ‘Mean Inc’ and ‘Variation’ fields of field set 318 is entered under the column labeled ‘W5.’ The CUSTOMER VARIATION module 130 uses the values provided in the column labeled ‘W5’ in the field set 318 to calculate outputs to the user interface screen 400 of FIG. 4. As shown in field set 412, a mean increase value of ‘0’ is entered in a column labeled ‘Mean Inc’, and a variation value of ‘5’ is entered in a column labeled ‘Variation.’ The ‘Mean Inc’ value in field set 412 reflects the sum of all ‘Mean Inc’ values for all part types in the field set 318 (in the sample inputs shown in field set 318 of FIG. 3, there is only one part type ‘A’). Likewise, the ‘Variation’ value shown in field set 412 reflects the sum of all ‘Variation’ values for all part types entered in the field set 318. The CUSTOMER VARIATION module 130 sums the values entered in the ‘Mean Inc’ and ‘Variation’ field set 412 and enters the result in the ‘Total’ column in field set 412.

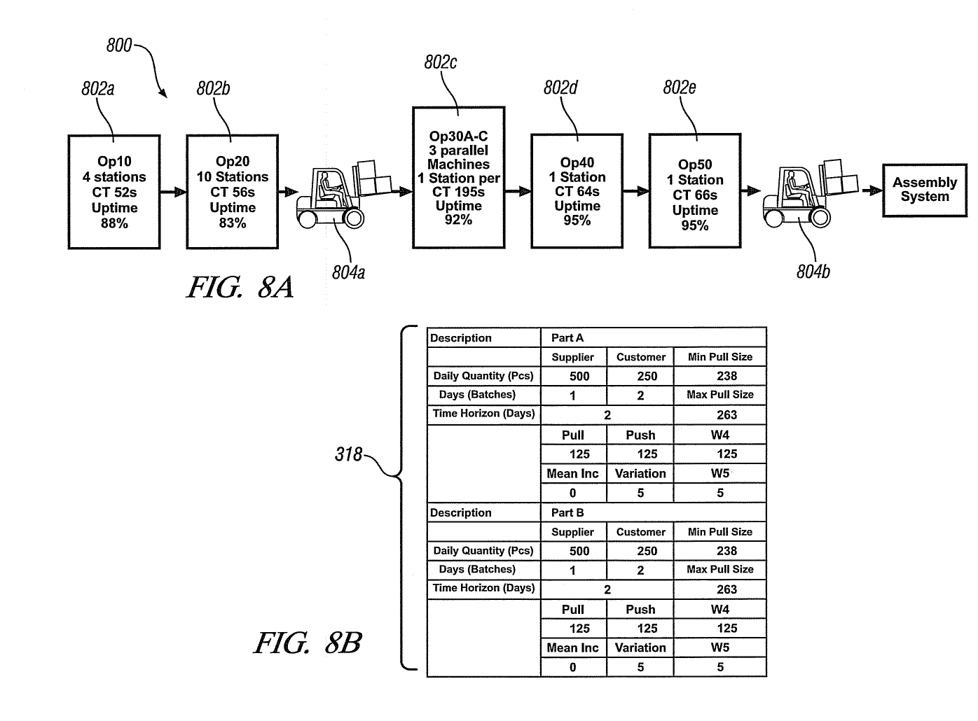

The data used in assessing the affects of process batching on WIP inventory in conjunction with a customer variation scenario are described in further detail with respect to FIGS. 8A and 8B. FIG. 8A represents a manufacturing system 800 that includes elements 802a-802e and 804a-804b, which are substantially similar to those described in FIG. 5 and, to this extent, will not be further described herein. FIG. 8B illustrates field set 318 with sample data for two part types (A and B). Each of the part types A and B represent a particular type of unit, or material of production. The example illustrated in FIG. 8B represents a model mix of 50% Part A and 50% Part B. For purposes of illustration (as shown in FIG. 8B), suppose that the batch process involves a supplier quantity of 500 units of Part type A (per day every second day) and 500 units of Part type B (per day every second day). Also assume that the batch process involves a customer quantity of 250 units (per day) for Part A and 250 units (per day) for Part B. A throughput variation has been assessed at 475 JPH to 525 JPH. The time horizon is input as ‘2’ since the supplier builds part type A for one day out of 2 and then builds part type B the next day.

Using the example field set 318 shown in FIG. 8B, the PROCESS BATCHING module 128 calculates the ‘Push’ and ‘Pull’ quantities shown in field set 318 for Part A and averages them to arrive at the value in the column labeled ‘W4’ in Part A. The same process is performed for other part types (e.g., Part B). In addition, the CUSTOMER VARIATION module 130 calculates the values in the columns labeled ‘W5’ in Parts A and B of the field set 318 of FIG. 8B by summing the respective values for ‘Mean Inc’ and ‘Variation.’

The processing of the field set 318, in conjunction with the model change values described in the field set 316 above, is used to derive values that are output to the user interface screen 400 of FIG. 4, as will now be described. Using the example field set 318 shown in FIG. 8B, the PROCESS BATCHING module 128 sums up the ‘Pull’ values in Parts A and B (and any additional Parts if applicable) of field set 318 and enters this value in field set 410 of FIG. 4 under the column ‘Pull.’ Likewise, the ‘Push’ values in Parts A and B (and any additional Parts if applicable) of field set 318 are added together and this value is entered in field set 410 of FIG. 4 under the column labeled ‘Push.’ Note that the column labeled ‘Model Change’ in field set 410 is populated with a value derived from the processing performed by the PLANNED DOWNTIME module 126 as described above.

The PROCESS BATCHING module 128 calculates the average of the two values in the ‘Pull’ and ‘Push’ columns of the data field set 410 and adds to this result the value from the column labeled ‘Model Change’ in field set 410. The result of this summation is entered in the column labeled ‘Total’ in the field set 410 of FIG. 4. As indicated above, the value in the column labeled ‘Model Change’ in field 410 represents the calculated increase to average inventory needed to reconcile any changes in the production of WIP inventory due to the planned model mix change-overs. The ‘Pull’ value in field set 410 assumes a perfect pull system which has an average of zero on the days between supply and pull. Additionally, the ‘Push’ value in field set 410 assumes a worst case push system which has an average of the total batch size on the days between supply and pull. Thus, the total value derived in field set 410 in the column labeled ‘Total’ represents the total calculated increase to average inventory related to process batching, i.e., change over plus the average of pull and push values. In one exemplary embodiment, the ‘total’ value in field set 410 may be derived via a formula 1110 shown in FIG. 11. The total value derived in field set 412 in the column labeled ‘Total’ represents the total calculated increase to average inventory related to customer schedule variation. In one exemplary embodiment, the ‘total’ value in field set 412 may be derived via a formula 1112 shown in FIG. 11.

While the above description represented in FIG. 8B illustrates the batch processing activities conducted and its related outputs, it will be understood that variations of batch processing methods may be employed using the inventory management processes of the invention. For example, the field set 318 of FIG. 3 may be used to determine inventory drivers of batch processing activities when a customer employs a delayed pull system (not shown). A delayed pull system refers to a system in which a customer pulls units on a delayed schedule (e.g., every two days). By way of example, suppose a supplier builds 1000 units of Part A and 1000 units of Part B and that it takes the supplier two days to build both batches of these units. Suppose that the customer pulls 1000 of Part A and B at the end of every two days. This may be reflected in the field set 318 by entering 1000 in the line labeled ‘Daily Quantity (Pcs)’ under the column ‘Supplier’ in Part A (not shown). The customer daily quantity (1000) is entered in the line labeled ‘Daily Quantity (Pcs)’ under the column ‘Customer’ in Part A (not shown).

The supplier builds Part A in one day of the two day horizon. This would be reflected as a ‘1’ entered in the line labeled ‘Days (Batches)’ in the ‘Supplier’ column of field set 318 (not shown). The customer pulls part type A on one day in the two-day time horizon (reflected as ‘1’ in the line labeled ‘Days (Batches)’ in the ‘Customer’ column of field set 318—not shown). If the supplier produces the batch on the same day the customer pulls, the PROCESS BATCHING module 128 calculates the additional inventory beyond the batch as ‘0.’ This value would be reflected in the column ‘Pull’ of field set 318 in Part A (not shown). Also, because the time horizon (two days) is larger than the pull frequency (one day), there is a potential delay of one day between the supply and pull beyond the best case scenario. Thus, the PROCESS BATCHING module 128 calculates an increase in inventory for that one day by 1000 pieces or by 500 pieces on average over the two day time horizon. This value would be reflected in the ‘Pull’ column of the field set 318 in Part A (not shown). The PROCESS BATCHING module 128 calculates the value in the column ‘W4’ of Part A in field set 318 as ‘250’ (the average of the pull and push values—not shown).

Turning back to FIG. 2, additional operational data inputs (step 204) include data for assessing the affects of supplier schedule variation on WIP inventory. Supplier schedule variation refers to parts required in raw goods inventory to protect the system from supplier and in-bound transportation variation. Using the sample data provided in field set 320 of FIG. 3, there is a daily usage of 250 units per day for a first supply (e.g., ‘Supply 1’) of field set 320. The term ‘Supply’ used in field set 320 represents a part, or unit type. ‘Daily usage’ refers to the number of units produced per part type (e.g., ‘Supply 1’) per day. While only a single ‘supply’ item line is shown in field set 320 of FIG. 3 for illustrative purposes, it will be understood that many supply items may be entered in field set 320. For example, if the user interface 300 of the application 112 is represented in a spreadsheet format, the user can add additional batch lines using a simple navigational option provided by the program. For illustrative purposes, suppose there is a second supply (Supply 2) (not shown) for a second part type (Part B). Suppose also there is a daily usage of 250 units per day for Supply 2. Finally, assume that the supplier of part A is expected to deliver their parts every five hours, while the supplier of Part B delivers every two hours. Using historical data for the respective suppliers, it is determined that the supplier of Part A can be up to one hour late with their delivery, while the supplier of Part B has only been late by a maximum of half an hour. As shown in field set 320 for Part A, a value of 5.0 hours is entered in a line labeled ‘Missed Window (hrs)’ and a value of 1.0 hour is entered in a line labeled ‘Late to Window (hrs).’ This means a supplier of Part A must deliver a number of parts every five hours and may occasionally deliver up to one hour late. Thus, one missed delivery would be measured in terms of the number of parts that would have been delivered within a five-hour time period. Alternatively, the inventory required to protect for one late delivery would be measured in terms of the number of parts scheduled for the particular delivery divided by the number of hours the supplier has historically been late. Likewise, for Part B, a value of 2.0 hours is entered in a line labeled ‘Missed Window (hrs)’ (not shown), and a value of 0.5 hours is entered in a line labeled ‘Late to Window (hrs)’ (not shown). This means a supplier of Part B must deliver every two hours and has a late window of up to 0.5 hours.

The SUPPLIER VARIATION module 132 uses the ‘Late to Window’ values and the ‘Missed Window’ values to calculate the values presented in a column labeled ‘W6’ of respective Parts A and B of field set 320. In an exemplary embodiment, the SUPPLIER VARIATION module 132 calculates the value in the column labeled ‘W6’ by first comparing, for each part type, the values entered in the ‘Late to Window’ and ‘Missed Window.’ SUPPLIER VARIATION module 132 uses this information in conjunction with data from field set 302 (i.e., hours per day), then calculates, for each part type, the amount of WIP inventory required for the larger of the ‘Late to Window’ and the ‘Missed Window’ and places this result in the ‘W6’ column for that part type. For example, using the sample data provided in FIG. 3, the system operates 10 hours per day (System Data illustrated in field set 302). In field set 320, the daily usage of Part A is 250, or 25 per hour (250/10). Since the supplier for this part may be one hour late, coverage for late shipments would be 25 parts (25*1). In addition, coverage for a missed shipment is 25 parts per hour multiplied by the number of hours between shipments (25*5), or 125 parts. The maximum of these two values is 125, which value is entered in the column labeled ‘W6’ for Part A in field set 320. Also, by way of example, suppose there is a daily usage of 250 parts for part B, or 25 per hour. Its late shipment time is 0.5 hours, so coverage for Part B is 12.5, or 13 pieces. Since this part is shipped every two hours, coverage for missed shipments is 25*2, or 50 parts.

The SUPPLIER VARIATION module 132 uses the values presented in field set 320 for each part type (e.g., Part A and Part B) to produce output values that are entered into ‘Late’ and ‘Missed’ columns shown in field set 414 of FIG. 4. For those parts whose ‘Late to Window’ WIP requirements are greater than ‘Missed Window,’ the values for ‘Late to Window (hrs)’ for each part are summed and entered into the ‘Late’ column of field set 414. Likewise, for those parts whose ‘Missed Window’ WIP requirements are greater than ‘Late to Window,’ the values for ‘Missed Window (hrs)’ for each part are summed and entered into the ‘Missed’ column of field set 414. Using the above example, the sum of the values for the column labeled ‘W6’ for Parts A and B is 175 (125 for Part A and 50 for Part B), as shown in field set 414 in the column labeled ‘Missed.’ The SUPPLIER VARIATION module 132 then sums the values entered in field set 414 (i.e., the values for ‘Late’ and ‘Missed’) to produce the value entered in the ‘Total’ column of field set 414. This total value represents the amount of WIP inventory required to cover for the expected time that a supplier will be late with a shipment and/or will miss a shipment. In one exemplary embodiment, the ‘total’ value in field set 414 may be derived via a formula 1114 shown in FIG. 11.

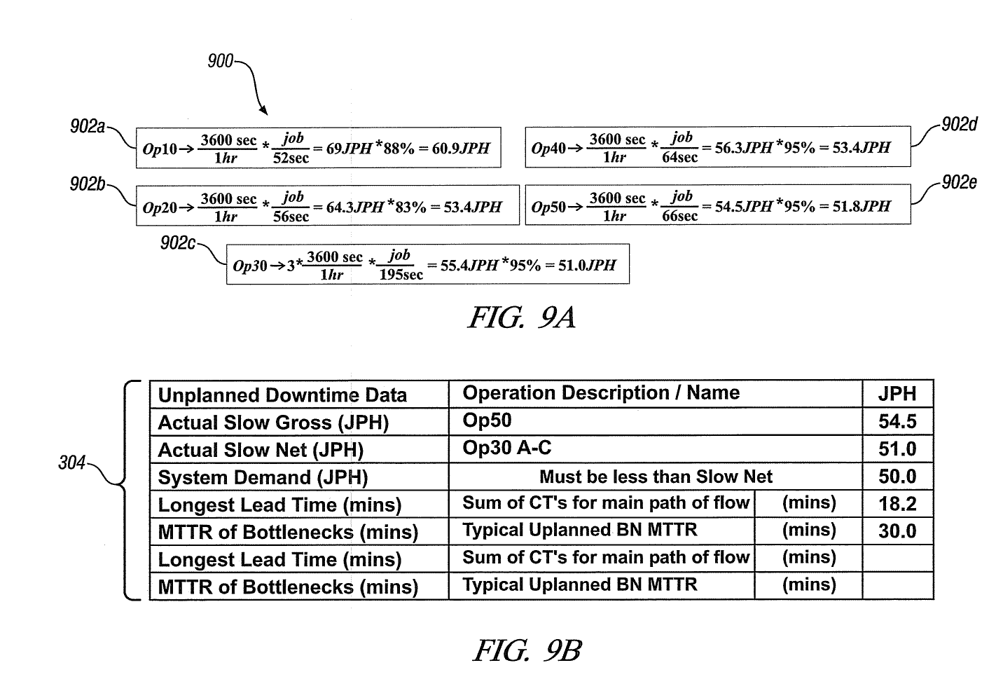

Returning now to FIG. 2, additional operational data inputs (step 204) include data for assessing the affects of unplanned downtime on WIP inventory. Using the example data provided in field set 304 of FIG. 3, the name and/or description of one or more of the slowest gross machines in the manufacturing environment (e.g., manufacturing system 500) is entered in a line labeled ‘Actual Slow Gross (JPH)’ in a column labeled ‘Operation Description/Name.’ The rate of the identified slow gross machine is entered in jobs per hour (JPH) in the line labeled ‘Actual Slow Gross (JPH)’ in a column labeled ‘JPH.’ The slow gross machine refers to the machine, or combination of machines in parallel, that have the longest cycle time. Using the sample manufacturing system 500 shown in FIG. 5, the slow gross machine is ‘Op50’ with a JPH of 54.5. Additionally, the name and/or description of one or more slow net machines of the manufacturing facility (e.g., system 500) is entered in a line labeled ‘Actual Slow Net’ in a column labeled ‘Operation Description/Name’ in field set 304. Adjacent to the name of the slow net machine, in the column labeled ‘JPH,’ the rate of this slow net machine is entered. The slow net machine refers to the machine or combination of machines in parallel that has the least JPH considering its cycle time and downtime, excluding blocked and starved time (e.g., it may be an identified bottleneck/constraint). These features are shown and described further in FIGS. 5 and 9A-9B, as will now be described.

The UNPLANNED DOWNTIME module 134 calculates the rate of the slow gross machine and the slow net machine using the calculations shown in FIG. 9A. A formula is executed for each of the machines/operations in the manufacturing system (e.g., 502a-502e). Using, e.g., the information provided in FIG. 5 for each equipment 502a-502e, the formulas 902a-902e convert cycle time to jobs per hour (JPH) which is a gross rate assuming it never fails (e.g., 502a/902a: 3600 sec/1 hr*job/52 sec=69 JPH; where 52 is the cycle time for 502a). The gross JPH rate (e.g., 69 JPH) is then multiplied by the uptime % (e.g., 88% for 502a) to get a net rate (e.g., 60.9 JPH), which reflects the machine rate including failures. As shown in FIG. 9A, ‘Op50’, or machine 502e, represents the slow gross machine as determined by the calculation 902e. Additionally, as shown in FIG. 9A, ‘Op30A-C, or machine 502c, represents the slow net machine (e.g., the operation with the lowest stand alone throughput) as determined by the calculation 902c.

Additional inputs include the calculated system demand rate on the manufacturing system in JPH. In an exemplary embodiment, the calculated system demand rate is based on inputs made in field set 302. The calculated system demand rate is derived by dividing the demand in field set 302 (shown as ‘500’) by the number of hours in field set 302 (shown as ‘10.0’). Using the inputs shown in field set 302, the calculated system demand rate is 500/10, or 50. This is reflected in field set 304 of FIG. 9B in a row labeled ‘System Demand (JPH)’ in a column labeled ‘JPH.’ As shown in field set 304, the processing time of a unit through the practical longest path in the manufacturing system is entered in a line labeled ‘Longest Lead Time (mins)’ in the column ‘JPH.’ In a serial manufacturing system, for example, this value may be derived by summation of each station's cycle time. For example, the sum of the cycle times of machines 502a-502e in FIG. 5 reflect a longest lead time of 18.2 minutes (CT 52 seconds*4 stations+CT 56 seconds*10 stations+CT 195 seconds+CT 64 seconds+CT 66 seconds=1093 seconds, or 18.2 minutes), where CT refers to cycle time. Also shown in field set 304, the typical mean time to repair (MTTR) is entered in a line labeled ‘MTTR of Bottlenecks (mins).’ This value represents the MTTR of the stations determined to have the greatest impact on the manufacturing system in terms of bottlenecks. For example, the short faults (at or near the cycle of the machine) may be removed from the MTTR number to allow the MTTR to better represent longer downtimes. This value may be calculated from a sampling of bottleneck stations, if desired.

As shown in FIG. 4, the UNPLANNED DOWNTIME module 134 uses the values provided in field set 304 of user interface screen 300 to produce the outputs shown in field set 416 of FIG. 4. There are three values associated with field set 416: Internal, Variation, and End of Line. ‘Internal’ refers to a calculated increase to average inventory internal to a system related to the system's average unplanned downtime (in units) (i.e., the amount of inventory needed within a system's buffering to protect for unplanned failures and provide the product at the customer's demand rate). ‘Variation’ refers to a calculated increase to average inventory to protect for typical variations in the MTTR of the bottleneck operations (in units) (i.e., the amount of inventory needed continue supplying the customer parts due to large amounts of variation in the failure rate). ‘End of Line’ refers to a calculated increase to average inventory at the end of a system due to the need to protect the customer from the system's unplanned downtime (in units) (i.e., assuming internal inventory is internal to the system, this is the inventory required at the end of the system to protect the customer from the suppliers normal failure rate).

The UNPLANNED DOWNTIME module 134 calculates the ‘Internal’ value of field set 416. The UNPLANNED DOWNTIME module 134 calculates the ‘Variation’ value of field set 416 and the ‘End of Line’ value of field set 416. The UNPLANNED DOWNTIME module 134 then sums the ‘Internal’, ‘Variation,’ and ‘End of Line’ values from field set 416 and places the result in the column ‘Total’ column of field set 416. In one exemplary embodiment, the ‘Internal,’ ‘Variation,’ and ‘End of Line’ values, including the summation of these values (i.e., the ‘total’ value in field set 416) may be derived via a formula 1116 shown in FIG. 11. The variables used in the formula 1116 are described below:

r_{g}—rate of bottleneck (i.e., operation having the lowest stand alone throughput)

LT—lead time to produce the product (i.e., the sum of each operation's cycle time*each operation's number of stations)

Demand—rate to protect for

MTTR—mean time to repair

#*MTTR—additional time to protect

Thus, using the example above, the ‘Internal’ value (i.e., the value for internal unplanned downtime) may be calculated as

$$1 / 2 * ( \frac{Demand * ( {r}_{b} * LT - 1 )}{{r}_{b} - Demand} - {r}_{b} * LT ) .$$

The ‘Variation’ value (i.e., the value for variation downtime) may be calculated as (5*MTTR*Demand).

The ‘End of Line’ value may be calculated as

$$Demand * 3.1 * LT * ( \frac{{r}_{g}}{{r}_{b}} - 1 ) ,$$

whereby the ‘Demand’ value is accessed from field set 302, the ‘LT’ value is the longest lead time from field set 304, the ‘R_{b}’ value is the slow gross machine from field set 304, and the ‘R_{b}’ value is the slow net machine from field set 304.

Turning back to FIG. 2, additional operational data inputs (step 204) include data for assessing the affects of first time quality (FTQ) data on WIP inventory. In an exemplary embodiment, FTQ refers to a performance metric that measures the first time pass rate (or yield) of processes and/or products of a defined set of operations. Using the example data provided in field set 322 of FIG. 3, the location and description of where the FTQ process occurs is entered in the respective locations in the field set 322. As shown in FIG. 3, for example, an offline inspection at a first location (Location 1) is described as ‘1 RACK PER DAY,’ an offline repair at a first location is described as ‘Op20,’ and a scrap process at a first location is described as ‘SYSTEM.’ For each of these FTQ processes, a percent of total production of parts/units taken offline is entered in a column labeled ‘%’ in the respective lines shown in field set 322. Additionally, the time in which the unit is in the FTQ process (e.g., for inspection and repair—the time may be the removal from system and return back into the system; for scrap—the time may be the removal from the system to removal from the inventory count balance) is entered in a column labeled ‘Time (mins)’ in the respective lines shown in field set 322. The FTQ module 136 uses these values to calculate the average inventory impact for the particular FTQ process. This result is entered on its respective line in fields set 322 under the column labeled ‘W8.’ By way of example, suppose that an FTQ process (Offline inspection) involves the first location, with a percentage value of 10.0%, and 600 minutes. The value of 10% reflects an inspection rate based on the daily demand. As shown in FIG. 3, field set 302 illustrates a daily demand of 500 parts. Thus, the inspection rate is 50 parts per day. The value of 600 minutes represents the number of minutes worked in a day. As shown in FIG. 3, field set 302 illustrates a work day of 10.0 hours (600/60=10). Thus, 50 parts are sent to inspection daily and it takes one day to inspect them. This value is entered in a column labeled ‘W8’ for offline inspection Location 1 in field set 322 of FIG. 3. Similar calculations are performed on the values provided for ‘Repair’ and ‘Scrap.’

The FTQ module 136 uses the values entered in the column ‘W8’ of field set 322 to calculate the output values shown in field set 418 of FIG. 4. The sums of the W8 values for respective inspection, repair, and scrap variables for each location are determined by the FTQ module 136 and entered in corresponding locations in field set 418. In turn, the FTQ module 136 adds together the values entered in the columns ‘Inspection,’ ‘Repair,’ and ‘Scrap’ of field set 418 and enters the result in the ‘Total’ column of field set 418. This value represents the total calculated increase to average inventory due to FTQ processes (inspection, repair, and scrap). In one exemplary embodiment, the ‘total’ value in field set 418 may be derived via a formula 1118 shown in FIG. 11.

Turning back to FIG. 2, additional operational data inputs (step 204) include data for assessing the affects of special causes WIP inventory (also referred to herein as ‘custom causes’). A special cause may be any other reason for an increase in inventory (other than those described above). Using the example data provided in field set 324 of FIG. 3, the name and/or description of one or more of the special causes is entered in a column labeled ‘Special Causes.’ The reason for the increase in inventory is entered in a column labeled ‘Reason’ in the field set 324 of FIG. 3. The value provided in a column labeled ‘Avg’ refers to the average number of units that are being held due to this special cause. For example, a special cause may be ‘End of Line Safety Stock-Major Breakdowns’ with an average unit of 100 (safety stock minimum). This value entered in field set 324 may be added and ‘averaged’ with other values similarly acquired for other special causes via the SPECIAL CAUSE module 138. The resulting value is then entered in the ‘Total’ column of field set 420 of FIG. 4.

As described above, the modules 120-138 process inputs and related data from inputs to the user interface screen 300, and provide calculated outputs in FIG. 4 according to each of the drivers of inventory (W0-W9). The inventory management application 112 sums the values in the total column of FIG. 4 for fields 402-420 and provides the result in a field 422 labeled ‘Total Average Inventory.’ The total average inventory reflects the calculated average of increased inventory due to all causes/drivers. In addition, the inventory management application 112 calculates the average daily inventory value for inventory within the manufacturing system and enters this value in a field set 426 of FIG. 4. The field set 426 ‘Total Average $ of Inventory’ may be derived by multiplying the value in field set 422 by the ‘Avg $/Piece’ value entered in field set 302 of FIG. 3 (shown as $5.00). Additionally, the inventory management application 112 calculates the total average days on hand and enters this value in a field set 424 of FIG. 4. The total average days on hand value reflects the calculated days of inventory related to the customer's daily demand. This value may be derived by dividing the value in field set 422 by the demand per day value in field set 302 (using the example data shown in FIG. 3, 1435/500=2.9, or ‘2’).

As indicated above, current, future, and ideal WIP inventory states are summarized in field sets 402 through 426 of FIG. 4. However, a separate model is created for each of these three states using different inputs. For example, field set 316 in FIG. 3 indicates a model change time of 30 minutes every two days, which results in a value representing increased requirements to WIP inventory due to model change. Assume this value represents the current state of the system (e.g., a manufacturing facility). In addition to entering this value in the column labeled ‘W4’ in field set 316, this value is also reflected in field set 410 of FIG. 4, and finally as part of the total average inventory calculated in fields set 422 of FIG. 4 (e.g., ‘1435’). However, assume a new model is created for a future state where the model change time in field set 316 is reduced to 15 minutes every two days. This would result in a lower value in field sets 316 (i.e., in the column labeled ‘W4’), 410, and 422 for that future state. In addition, a third model may be created for the ideal state in which there is no model change time. This would be reflected in field set 316 (as ‘zero’) and the values in field sets 410 and 422 would be lowered correspondingly.

The inventory management processes not only quantify inventory required but also the reasons for which is needed. Each driver is implemented as a module 120-138. By determining the WIP inventory by cause or driver, the inventory management processes enable manufacturing entities to identify which drivers of inventory have the greatest impact on the system, as well as to assess changes or improvements that may be made to reduce inventory where possible.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A method of managing work-in-process (WIP) inventory, comprising:
receiving inputs, via a user interface of a computer processing device, the inputs corresponding to variables defined for modules, each of the modules comprising a set of instructions for determining and quantifying a corresponding WIP inventory driver, wherein WIP inventory drivers each represents distinct elements that impact at least one of acquisition, handling, and movement of the WIP inventory;
executing instructions on the inputs by one or more of the modules, the inputs applied to corresponding one or more of the modules based on respective variables defined for the modules; and
deriving a quantified WIP inventory resulting from execution of the instructions, the quantified WIP inventory categorized by corresponding WIP inventory drivers.

2. The method of claim 1, wherein the inputs comprise values reflecting a current state of a manufacturing system, the current state representing levels of WIP inventory as currently existing in the manufacturing system the method further comprising:
generating a re-usable model that represents the quantified WIP inventory derived from execution of the instructions with respect to the current state.

3. The method of claim 1, wherein the inputs comprise values reflecting a prospective state of a manufacturing system, the prospective state representing unrealized levels of WIP inventory that are based upon a prospective manufacturing plan, the method further comprising:
generating a re-usable model that represents the quantified WIP inventory derived from execution of the instructions with respect to the prospective state.

4. The method of claim 1, wherein the inputs comprise values reflecting an ideal state of a manufacturing system, the ideal state reflecting levels of WIP inventory determined to keep the manufacturing system running at a maximum capacity defined for the manufacturing system, the method further comprising:
generating a re-usable model that represents the quantified WIP inventory derived from execution of the instructions with respect to the ideal state.

5. The method of claim 1, wherein the modules include a system fill module and the variables used by the system fill module include a summation of buffering locations, an index time reflecting an average amount of time it takes for a WIP inventory material to transit the buffering locations, machine cycle times for machines located on each end of a conveyor transporting the WIP inventory material, and batch move times for load and unload batch operations, the method further comprising:
using inputs for the corresponding variables, the system fill module determines a quantity of WIP inventory materials conveyed between machines and a quantity of WIP inventory materials identified for move batching operations, and sums the total number of stations, the quantity of WIP inventory materials conveyed between machines, and the quantity of WIP inventory materials identified for move batching operations;
wherein the quantified WIP inventory resulting from execution of the system fill module includes an increase to average WIP inventory determined to maintain a percentage of uptime with respect to machines running.

6. The method of claim 5, wherein the modules include a move batching module and the variables used by the move batching module include a number of units identified in preparation for loading to an operation, a number of units collected after completion of the operation and in preparation for a next operation, and the batch moves for load and unload batch operations;
wherein the quantified WIP inventory resulting from execution of the move batching module includes any increase to average WIP inventory due to moving containers of WIP inventory materials.

7. The method of claim 1, wherein the modules include a shift pattern module, and the variables used by the shift pattern module include a time difference identified between two systems that make up the shift pattern, a frequency of occurrence of the shift pattern, and a daily demand, the method further comprising:
using inputs for the corresponding variables, the shift pattern module calculates any increase to average WIP inventory due to the shift pattern by multiplying the daily demand by the time difference and dividing a result by the frequency of occurrence;
wherein the quantified WIP inventory resulting from execution of the shift pattern module includes any increase to average WIP inventory due to disparate running times attributed to shift patterns identified for manufacturing processes.

8. The method of claim 1, wherein the modules include a planned downtime module and the variables used by the planned downtime module include a time duration of a planned downtime for an operation and a frequency of occurrence of the planned downtime for the operation, the method further comprising:
using inputs for the corresponding variables, the planned downtime module calculates any increase to average WIP inventory due to planned downtimes for each operation, and sums results of calculations for the planned downtimes;
wherein the quantified WIP inventory resulting from execution of the planned downtime module includes any increase to average WIP inventory due to planned downtimes.

9. The method of claim 8, wherein the operation subject to the planned downtime includes a model change over between part types, wherein the quantified WIP inventory resulting from execution of the planned downtime module includes any increase to average WIP inventory due to the model change over; and
wherein further, the modules include a process batching module and the variables used by the process batching module include a daily quantity of parts pulled for each part type, a daily quantity of parts pushed for each part type, a number of days a supplier builds the part type in a specified time horizon, and a number of days a customer pulls the part type in the specified time horizon, the method further comprising:
using inputs for the corresponding variables, the process batching module calculates any increase to average WIP inventory due to process batching, comprising:
calculating a push value from the daily quantity of parts, the number of days the supplier builds the part type over the specified time horizon, the number of days the customer pulls the part type over the specified time horizon, and a push system in which the supplier produces with a greatest possible delay between production and customer pulls for the parts;
calculating a pull value from the daily quantity of parts, the number of days the supplier builds the part type over the specified time horizon, the number of days the customer pulls the part type over the specified time horizon, and a pull system in which the supplier produces the parts when the customer pulls the parts;
averaging the push and pull values;
summing averaged push and pull values for each part type; and
adding together a summed average of the push and pull values with the increase, if any, to WIP inventory due to the model change over;
wherein the quantified WIP inventory resulting from execution of the process batching module includes any increase to average WIP inventory due to process batching and model change overs.

10. The method of claim 9, wherein the modules include a customer variation module and the variables used by the customer variation module include a minimum pull size representing a value reflecting a maximum quantity of parts the customer is expected to pull based upon the daily quantity of parts pulled for each part type, a maximum pull size representing a value reflecting a minimum quantity of parts the customer is expected to pull based upon the daily quantity of parts pulled for each part type, a mean increase representing a value reflecting a predicted increase in production based on a measurable sustained increase in pulls by the customer, and a variation representing a value reflecting a calculated increase in buffer size to account for variations in customer pulls;
using inputs for the corresponding variables, the customer variation module calculates any increase to average WIP inventory due to customer schedule variations;
wherein the quantified WIP inventory resulting from execution of the customer variation module includes any increase to average WIP inventory due to customer schedule variations.

11. The method of claim 1, wherein the modules include a supplier variation module and the variables used by the supplier variation module include a daily usage variable representing a number of parts produced per part type, a late to window variable reflecting a maximum amount of time the supplier has historically been late delivering parts, and a missed window variable reflecting a number of hours between scheduled deliveries of the parts;
using inputs for the corresponding variables, the supplier variation module calculates any increase to average WIP inventory due to supplier delivery variations;
wherein the quantified WIP inventory resulting from execution of the supplier variation module includes any increase to average WIP inventory due to variations in supplier deliveries.

12. A system for of managing work-in-process (WIP) inventory, comprising:
a host system computer; and
an application executing on the host system computer, the application including modules and a user interface, the application implementing a method comprising:
receiving inputs, via the user interface of the application, the inputs corresponding to variables defined for the modules, each of the modules comprising a set of instructions for determining and quantifying a corresponding WIP inventory driver, wherein WIP inventory drivers each represents distinct elements that impact at least one of acquisition, handling, and movement of the WIP inventory;
executing a respective set of instructions on the inputs by one or more of the modules, the inputs applied to corresponding one or more of the modules based on respective variables defined for the modules; and
deriving a quantified WIP inventory resulting from execution of the set of instructions, the quantified WIP inventory categorized by corresponding WIP inventory drivers.

13. The system of claim 12, wherein the inputs comprise values reflecting a current state of a manufacturing system, the current state representing levels of WIP inventory as currently existing in the manufacturing system, the method further comprising:
generating a re-usable model that represents the quantified WIP inventory derived from execution of the set of instructions with respect to the current state.

14. The system of claim 12, wherein the inputs comprise values reflecting a prospective state of a manufacturing system, the prospective state representing unrealized levels of WIP inventory that are based upon a prospective manufacturing plan, the method further comprising:
generating a re-usable model that represents the quantified WIP inventory derived from execution of the set of instructions with respect to the prospect state.

15. The system of claim 12, wherein the inputs comprise values reflecting an ideal state of a manufacturing system, the ideal state reflecting levels of WIP inventory determined to keep the manufacturing system running at a maximum capacity defined for the manufacturing system, the method further comprising:
generating a re-usable model that represents the quantified WIP inventory derived from execution of the set of instructions with respect to the ideal state.

16. The system of claim 12, wherein the modules include a system fill module and the variables used by the system fill module include a summation of buffering locations, an index time reflecting an average amount of time it takes for a WIP inventory material to transit the buffering locations, machine cycle times for machines located on each end of a conveyor transporting the WIP inventory material, and batch move times for load and unload batch operations, the method further comprising:
using inputs for the corresponding variables, the system fill module determines a quantity of WIP inventory materials conveyed between machines and a quantity of WIP inventory materials identified for move batching operations, and sums the total number of stations, the quantity of WIP inventory materials conveyed between machines, and the quantity of WIP inventory materials identified for move batching operations;
wherein the quantified WIP inventory resulting from execution of the system fill module includes an increase to average WIP inventory determined to maintain a percentage of uptime with respect to machines running.

17. The system of claim 16, wherein the modules include a move batching module and the variables used by the move batching module include a number of units identified in preparation for loading to an operation, a number of units collected after completion of the operation and in preparation for a next operation, and the batch moves for load and unload batch operations;
wherein the quantified WIP inventory resulting from execution of the move batching module includes any increase to average WIP inventory due to moving containers of WIP inventory materials.

18. The system of claim 12, wherein the modules include a shift pattern module, and the variables used by the shift pattern module include a time difference identified between two systems that make up the shift pattern, a frequency of occurrence of the shift pattern, and a daily demand, the method further comprising:
using inputs for the corresponding variables, the shift pattern module calculates any increase to average WIP inventory due to the shift pattern by multiplying the daily demand by the time difference and dividing a result by the frequency of occurrence;
wherein the quantified WIP inventory resulting from execution of the shift pattern module includes any increase to average WIP inventory due to disparate running times attributed to shift patterns identified for manufacturing processes.

19. The system of claim 12, wherein the modules include a planned downtime module and the variables used by the planned downtime module include a time duration of a planned downtime for an operation and a frequency of occurrence of the planned downtime for the operation, the method further comprising:
using inputs for the corresponding variables, the planned downtime module calculates any increase to average WIP inventory due to planned downtimes for each operation, and sums results of calculations for the planned downtimes;
wherein the quantified WIP inventory resulting from execution of the planned downtime module includes any increase to average WIP inventory due to planned downtimes.

20. The system of claim 19, wherein the operation subject to the planned downtime includes a model change over between part types, wherein the quantified WIP inventory resulting from execution of the planned downtime module includes any increase to average WIP inventory due to the model change over; and
wherein further, the modules include a process batching module and the variables used by the process batching module include a daily quantity of parts pulled for each part type, a daily quantity of parts pushed for each part type, a number of days a supplier builds the part type in a specified time horizon, and a number of days a customer pulls the part type in the specified time horizon, the method further comprising:
using inputs for the corresponding variables, the process batching module calculates any increase to average WIP inventory due to process batching, comprising:
calculating a push value from the daily quantity of parts, the number of days the supplier builds the part type over the specified time horizon, the number of days the customer pulls the part type over the specified time horizon, and a push system in which the supplier produces with a greatest possible delay between production and customer pulls for the parts;
calculating a pull value from the daily quantity of parts, the number of days the supplier builds the part type over the specified time horizon, the number of days the customer pulls the part type over the specified time horizon, and a pull system in which the supplier produces the parts when the customer pulls the parts;
averaging the push and pull values;
summing averaged push and pull values for each part type; and
adding together a summed average of the push and pull values with the increase, if any, to WIP inventory due to the model change over;
wherein the quantified WIP inventory resulting from execution of the process batching module includes any increase to average WIP inventory due to process batching and model change overs.

21. The system of claim 20, wherein the modules include a customer variation module and the variables used by the customer variation module include a minimum pull size representing a value reflecting a maximum quantity of parts the customer is expected to pull based upon the daily quantity of parts pulled for each part type, a maximum pull size representing a value reflecting a minimum quantity of parts the customer is expected to pull based upon the daily quantity of parts pulled for each part type, a mean increase representing a value reflecting a predicted increase in production based on a measurable sustained increase in pulls by the customer, and a variation representing a value reflecting a calculated increase in buffer size to account for variations in customer pulls;
using inputs for the corresponding variables, the customer variation module calculates any increase to average WIP inventory due to customer schedule variations;
wherein the quantified WIP inventory resulting from execution of the customer variation module includes any increase to average WIP inventory due to customer schedule variations.

22. The system of claim 12, wherein the modules include a supplier variation module and the variables used by the supplier variation module include a daily usage variable representing a number of parts produced per part type, a late to window variable reflecting a maximum amount of time the supplier has historically been late delivering parts, and a missed window variable reflecting a number of hours between scheduled deliveries of the parts;
using inputs for the corresponding variables, the supplier variation module calculates any increase to average WIP inventory due to supplier delivery variations;
wherein the quantified WIP inventory resulting from execution of the supplier variation module includes any increase to average WIP inventory due to variations in supplier deliveries.

23. A computer program product for managing work-in-process (WIP) inventory, the computer program product comprising a storage medium encoded with machine-readable computer program code, which when executed by a computer implements a method, the comprising:
receiving inputs corresponding to variables defined for modules, each of the modules comprising a set of instructions for determining and quantifying a corresponding WIP inventory driver, wherein WIP inventory drivers each represents distinct elements that impact at least one of acquisition, handling, and movement of the WIP inventory;
executing a respective set of instructions on the inputs by one or more of the modules, the inputs applied to corresponding one or more of the modules based on respective variables defined for the modules; and
deriving a quantified WIP inventory resulting from execution of the set of instructions, the quantified WIP inventory categorized by corresponding WIP inventory drivers.

24. The computer program product of claim 23, wherein the inputs comprise values reflecting a current state of a manufacturing system, the current state representing levels of WIP inventory as currently existing in the manufacturing system the method further comprising:
generating a re-usable model that represents the quantified WIP inventory derived from execution of the set of instructions with respect to the current state.

25. The computer program product of claim 23, wherein the inputs comprise values reflecting a prospective state of a manufacturing system, the prospective state representing unrealized levels of WIP inventory that are based upon a prospective manufacturing plan, the method further comprising:
generating a re-usable model that represents the quantified WIP inventory derived from execution of the set of instructions with respect to the prospect state.

26. The computer program product of claim 23, wherein the inputs comprise values reflecting an ideal state of a manufacturing system, the ideal state reflecting levels of WIP inventory determined to keep the manufacturing system running at a maximum capacity defined for the manufacturing system, the method further comprising:
generating a re-usable model that represents the quantified WIP inventory derived from execution of the set of instructions with respect to the ideal state.

27. The computer program product of claim 23, wherein the modules include a system fill module and the variables used by the system fill module include a summation of buffering locations, an index time reflecting an average amount of time it takes for a WIP inventory material to transit the buffering locations, machine cycle times for machines located on each end of a conveyor transporting the WIP inventory material, and batch move times for load and unload batch operations, the method further comprising:
using inputs for the corresponding variables, the system fill module determines a quantity of WIP inventory materials conveyed between machines and a quantity of WIP inventory materials identified for move batching operations, and sums the total number of stations, the quantity of WIP inventory materials conveyed between machines, and the quantity of WIP inventory materials identified for move batching operations;
wherein the quantified WIP inventory resulting from execution of the system fill module includes an increase to average WIP inventory determined to maintain a percentage of uptime with respect to machines running.

28. The computer program product of claim 27, wherein the modules include a move batching module and the variables used by the move batching module include a number of units identified in preparation for loading to an operation, a number of units collected after completion of the operation and in preparation for a next operation, and the batch moves for load and unload batch operations;
wherein the quantified WIP inventory resulting from execution of the move batching module includes any increase to average WIP inventory due to moving containers of WIP inventory materials.

29. The computer program product of claim 23, wherein the modules include a shift pattern module, and the variables used by the shift pattern module include a time difference identified between two systems that make up the shift pattern, a frequency of occurrence of the shift pattern, and a daily demand, the method further comprising:
using inputs for the corresponding variables, the shift pattern module calculates any increase to average WIP inventory due to the shift pattern by multiplying the daily demand by the time difference and dividing a result by the frequency of occurrence;
wherein the quantified WIP inventory resulting from execution of the shift pattern module includes any increase to average WIP inventory due to disparate running times attributed to shift patterns identified for manufacturing processes.

30. The computer program product of claim 23, wherein the modules include a planned downtime module and the variables used by the planned downtime module include a time duration of a planned downtime for an operation and a frequency of occurrence of the planned downtime for the operation, the method further comprising:
using inputs for the corresponding variables, the planned downtime module calculates any increase to average WIP inventory due to planned downtimes for each operation, and sums results of calculations for the planned downtimes;
wherein the quantified WIP inventory resulting from execution of the planned downtime module includes any increase to average WIP inventory due to planned downtimes.

31. The computer program product of claim 30, wherein the operation subject to the planned downtime includes a model change over between part types, wherein the quantified WIP inventory resulting from execution of the planned downtime module includes any increase to average WIP inventory due to the model change over; and
wherein further, the modules include a process batching module and the variables used by the process batching module include a daily quantity of parts pulled for each part type, a daily quantity of parts pushed for each part type, a number of days a supplier builds the part type in a specified time horizon, and a number of days a customer pulls the part type in the specified time horizon, the method further comprising:
using inputs for the corresponding variables, the process batching module calculates any increase to average WIP inventory due to process batching, comprising:
calculating a push value from the daily quantity of parts, the number of days the supplier builds the part type over the specified time horizon, the number of days the customer pulls the part type over the specified time horizon, and a push system in which the supplier produces with a greatest possible delay between production and customer pulls for the parts;
calculating a pull value from the daily quantity of parts, the number of days the supplier builds the part type over the specified time horizon, the number of days the customer pulls the part type over the specified time horizon, and a pull system in which the supplier produces the parts when the customer pulls the parts;
averaging the push and pull values;
summing averaged push and pull values for each part type; and
adding together a summed average of the push and pull values with the increase, if any, to WIP inventory due to the model change over;
wherein the quantified WIP inventory resulting from execution of the process batching module includes any increase to average WIP inventory due to process batching and model change overs.

32. The computer program product of claim 31, wherein the modules include a customer variation module and the variables used by the customer variation module include a minimum pull size representing a value reflecting a maximum quantity of parts the customer is expected to pull based upon the daily quantity of parts pulled for each part type, a maximum pull size representing a value reflecting a minimum quantity of parts the customer is expected to pull based upon the daily quantity of parts pulled for each part type, a mean increase representing a value reflecting a predicted increase in production based on a measurable sustained increase in pulls by the customer, and a variation representing a value reflecting a calculated increase in buffer size to account for variations in customer pulls;
using inputs for the corresponding variables, the customer variation module calculates any increase to average WIP inventory due to customer schedule variations;
wherein the quantified WIP inventory resulting from execution of the customer variation module includes any increase to average WIP inventory due to customer schedule variations.

33. The computer program product of claim 23, wherein the modules include a supplier variation module and the variables used by the supplier variation module include a daily usage variable representing a number of parts produced per part type, a late to window variable reflecting a maximum amount of time the supplier has historically been late delivering parts, and a missed window variable reflecting a number of hours between scheduled deliveries of the parts;
using inputs for the corresponding variables, the supplier variation module calculates any increase to average WIP inventory due to supplier delivery variations;
wherein the quantified WIP inventory resulting from execution of the supplier variation module includes any increase to average WIP inventory due to variations in supplier deliveries.
